(19) United States
(12) Patent Application Publication
(10) Pub. No.: US 2026/0179945 A1
(43) Pub. Date: Jun. 25, 2026

(54) FREE PARTICLES AND METHODS FOR MAKING FOR USE IN ELECTROCHEMICAL CELLS

(71) Applicant: Novonix Battery Technology Solutions Inc., Dartmouth (CA)

(72) Inventors: Mark Nikolas Obrovac, Halifax (CA); Moarij Ali Syed, Halifax (CA); Pierre-Emmanuel Bes de Berc, Halifax (CA)

(21) Appl. No.: 19/126,209

(22) PCT Filed: Nov. 3, 2023
(86) PCT No.: PCT/US2023/078728

§ 371 Date: Apr. 30, 2025

Related U.S. Application Data
(60) Provisional application No. 63/423,275, filed on Nov. 7, 2022.
(60) Provisional application No. 63/580,294, filed on Sep. 1, 2023.

(51) Int. Cl. H01M 4/58; H01M 4/02; H01M 4/131; H01M 4/136; H01M 4/1397; H01M 4/36; H01M 4/485; H01M 4/525; H01M 4/62; H01M 10/052

(52) U.S. Cl. CPC H01M 4/5825; H01M 4/131; H01M 4/136; H01M 4/1397; H01M 4/366; H01M 4/485; H01M 4/525; H01M 4/625; H01M 10/052; H01M 2004/021

(57) ABSTRACT

Facile methods are disclosed for making free particles (for example, comprising LiFePO₄ or NMC) which can be particularly useful as electrode materials in lithium batteries and other applications. Some methods involve dry mechanofusing suitable feedstock and template particles such that feedstock particles coat the template particles to form a coating, impact milling the coated template particles such that particles of the coating break off the template particles and then separating the broken off free particles from the template particles. Novel free particles produced by these methods can be characterized by an inter-grain layered structure identifiable by its preferred orientation characteristics. Such free particles can have uniquely low surface areas and electrodes made therewith can have uniquely low porosities yet high loadings and exhibit improved performance in electrochemical cells.

### INCORPORATION BY REFERENCE TO ANY PRIORITY APPLICATIONS

This application is a national stage application under 35 U.S.C. § 371 of International Application No. PCT/US2023/078728, filed on Nov. 3, 2023, which published in English as WO 2024/102624 on May 16, 2024, and which claims priority benefit of U.S. Provisional Patent Application Nos. 63/580,294, filed Sep. 1, 2023 and 63/423,275, filed Nov. 7, 2022. Any and all applications for which a foreign or domestic priority claim is identified in the Application Data Sheet as filed with the present application are hereby incorporated by reference under 37 CFR 1.57.

### BACKGROUND

### Field

The present disclosure pertains to facile methods for making free particles which are particularly useful as electrode materials in lithium batteries and other applications. Further, the disclosure also pertains to free particles and particulate that can be made by these methods which have uniquely low surface areas and to electrodes made therewith which have uniquely low porosities yet high loadings.

### Related Art

The development of rechargeable high energy density batteries, such as Li-ion batteries, is of great technological importance. Typically, commercial rechargeable Li-ion batteries use a lithium transition metal oxide or a lithium iron phosphate cathode and a graphite anode. While batteries based on such materials are approaching their theoretical energy density limit, significant research and development continues in order to improve other important characteristics such as cycle life, efficiency, and cost.

To make Li-ion battery cathodes, Li-ion battery cathode materials can be mixed with carbon black and a binder dissolved in a solvent to form a slurry, a wet process. The slurry is then cast onto an electrode current collector. The cast cathodes are then heated to evaporate the solvent. This results in the formation of a coating of Li-ion battery cathode material powder, carbon black, and binder (the cathode coating) residing on the surface of the electrode current collector. Typically, both sides of the current collector are coated. Cathodes are typically coated with an amount of coating per each side (the loading) corresponding to a 2-4 mAh/cm² real capacity range per each side, depending on the application. As-dried cathode coatings can have porosities of about 50%. Li-ion battery cathodes may be calendered to increase energy density. Achieving even 25-35% porosities requires high calendering pressures (for example, 200-300 MPa) that can fracture cathode particles, leading to increased electrolyte reactivity, poor electrical contact and battery capacity fade.

LFP cathode materials can have low electronic conductivity and low Li⁺ ionic conductivity compared to the intra-grain layered crystal structure of oxide or spinel type cathode materials. To overcome this deficiency, LFP may be in the form of small particles (for example, 0.2-0.5 μm) to reduce Li⁺ diffusion lengths. Although the use of such LFP particles results in an improvement in electronic conductivity and Li⁺ ionic conductivity, the large surface area of the small particles increases electrolyte reactivity and also results in reduced packing efficiency.

To increase the energy density of LFP electrodes, high calendering pressures have been employed. However, this can lead to particle fracture and reduced electrode porosity which will lead to poor electrolyte infiltration and hence poor Lit diffusion in the electrolyte, as explained by [Xin Ren, Zhenfei Li, Yi Zheng, Weichao Tian, Kaicheng Zhang, Jingrui Cao, Shiyu Tian, Jianling Guo, Lizhi Wen, and Guangchuan Liang, High Volumetric Energy Density of LiFePO4 Battery Based on Ultrasonic Vibration Combined with Thermal Drying Process, Journal of the Electrochemical Society, 167 (2020) 130523]: “However, in the process of calendaring, blindly increasing the pressure from the roller press or the number of rolling will reduce the pole piece porosity and arouse fragmentation of active particles. Low porosity will cause the insufficient wetting of the electrolyte, which will affect the cycle performance of the LIBs, and the fragmentation of active particles will also lead to the poor electrochemical performance of LIBs.”

Various methods have been attempted to increase Li-ion battery energy density. Lei Wen et al. in Particuology, 22 (2015) 24 reported a cathode coating density of 2.6 g/cm³ utilizing LFP-carbon composite spheres, but to obtain acceptable performance, the LFP-GC spheres were highly porous. Yong Wang et al. in Ionics, 27 (2021) 4687 reported achieving a LFP cathode coating density of 2.73 g/cm³, however, this coating density was only achieved at an extremely small loading of 1 mg LFP/cm² (or approximately 0.16 mAh/cm²), which is far below what is useful in practical cells (about 2-4 mAh/cm²).

One method of producing particles is by ball milling. For instance, Keita Nagano et al. in U.S. Pat. No. 8,999,054 and “Metallic Effect Pigments: Fundamentals and Applications” by Peter Wissling et al., Vincentz Network (Apr. 1, 2006) describe the production of Al powder pigments made by ball milling Al powder. During the ball milling process, the powder is reduced in size and becomes flattened. A wet processing aid (for example, stearic acid) is added to control the amount of cold welding that takes place, so that large agglomerates are not formed. In this process, the starting Al powder is larger than the final flake particles. Pee-Yew Lee et al. in Journal of Materials Science, 33 (1998) 235 and Simeng Cao et al. in Journal of the Electrochemical Society, 169 (2022) 060540 (hereinafter “Pee-Yew et al.”) describe the synthesis of alloy flakes by ball milling. Flakes larger than the starting powder particles may be produced by ball milling powders that are both ductile and can adhere to each other by cold-welding. If the ball milling process is allowed to continue for an excessive amount of time, the alloys used in the milling may become brittle, resulting in fracture and destruction of the flakes. Ball milling processes are also limited in ball sizes which can be practically used. According to the Pee-Yew Lee et al.: “If grinding media having diameters exceeding 1.0 mm occupy most part, the fine aluminum powder is trapped between the grinding media and this aluminum powder is hardly ground and not efficiently flaked. If grinding media having diameters of less than 0.3 mm occupy most part, on the other hand, the weight of the steel ball grinding media is so small that grinding force is deteriorated, the grinding time is too long and the aluminum powder cannot be substantially ground.” Pee-Yew Lee et al. notes that ball milling is limited in functionality: “In other words, it is important in the inventive manufacturing method to flake aluminum powder with grinding media containing grinding media having diameters of 0.3 to 1.0 mm.” Thus, ball milling methods are unable to impart upon the flakes a radius of curvature less than 150 μm.

Considering the above, a method is needed in which brittle powders can be consolidated into flakes that are 5-25 μm in diameter. The ability to impart a radial curvature of less than 150 μm is also needed when such curved flakes are desired.

There is a need to increase the electrode coating density beyond what is currently practiced, while maintaining or exceeding electrode performance (i.e. high capacity retention and low polarization) and while maintaining or reducing electrode surface area to reduce reactivity with electrolyte or electrolyte additives. The present disclosure addresses these needs and provides further benefits as disclosed below.

### SUMMARY

In some aspects, the techniques described herein relate to a method of making free particles including: obtaining an amount of feedstock particles and an amount of template particles; dry mechanofusing the amounts of the feedstock particles and the template particles to form coated template particles including a feedstock particle coating on the template particles; impact milling the coated template particles such that the feedstock particle coating breaks off the template particles to form free particles; and separating the free particles from the template particles.

In some aspects, the techniques described herein relate to a method, wherein the template particles are spherically shaped and less than 200 μm in diameter.

In some aspects, the techniques described herein relate to a method, wherein the template particles are ZrO₂.

In some aspects, the techniques described herein relate to a method, wherein the feedstock particles include a transition metal oxide or a transition metal phosphate.

In some aspects, the techniques described herein relate to a method, wherein the feedstock particles include AₓT_{y}M_{z}O₂ or AₓT_{y}M_{z}PO₄, wherein: x≥0; y≥0.5; z≥0; A is one or more insertable alkali metals; T is one or more first row transitional metals; and M is selected from the group consisting of Mg, Al, Ti, Zr, W, Zn, Mo, K, Na, Si, Nb, and Ta.

In some aspects, the techniques described herein relate to a method, wherein the feedstock particles include LiFePO₄ and graphite and the free particles include a blend of LiFePO₄ and graphite.

In some aspects, the techniques described herein relate to a method, wherein the feedstock particles include NMC and the free particles include NMC.

In some aspects, the techniques described herein relate to a method wherein the amounts of feedstock particles and template particles obtained are such that the ratio of the true volume of feedstock particles to the surface area of the template particles corresponds to a coating thickness of 0.1 μm-50 μm.

In some aspects, the techniques described herein relate to a method wherein the impact milling is centrifugal impact milling.

In some aspects, the techniques described herein relate to a method wherein the mechanofusing time is in a range from 30 seconds to 5 hours.

In some aspects, the techniques described herein relate to a method wherein the impact milling time is in a range from 5 seconds to 1 minute.

In some aspects, the techniques described herein relate to a method further including heating the free particles that have been separated from the template particles at temperatures exceeding 200 degrees Celsius to produce an electroactive cathode material.

In some aspects, the techniques described herein relate to a free particulate including free particles made by the method comprising obtaining an amount of feedstock particles and an amount of template particles; dry mechanofusing the amounts of the feedstock particles and the template particles to form coated template particles including a feedstock particle coating on the template particles; impact milling the coated template particles such that the feedstock particle coating breaks off the template particles to form free particles; and separating the free particles from the template particles.

In some aspects, the techniques described herein relate to an electrode for an electrochemical cell including a porous electroactive coating on a current collector wherein the electroactive coating includes free particulate made by the method comprising obtaining an amount of feedstock particles and an amount of template particles; dry mechanofusing the amounts of the feedstock particles and the template particles to form coated template particles including a feedstock particle coating on the template particles; impact milling the coated template particles such that the feedstock particle coating breaks off the template particles to form free particles; and separating the free particles from the template particles.

In some aspects, the techniques described herein relate to a free particulate including free particles of electroactive material that include greater than 80% by weight of a metal oxide or a metal phosphate electroactive phase, have a density greater than 3 g/ml, an average particle size in a range from 1 μm to 30 μm, and wherein the metal oxide or a metal phosphate electroactive phase consists essentially of crystalline grains between 20 nm and 300 nm in size, wherein: the metal oxide and metal phosphate grains in the free particles have a preferred orientation with respect to the major plane of the particles with a preferred orientation parameter that is greater than 1.02 or less than 0.98; the free particles have an average internal porosity less than 20%; the volumetric surface area of the free particles is less than 30 m²/ml, and the average aspect ratio of the free particles is greater than 1.5.

In some aspects, the techniques described herein relate to a free particulate wherein the free particles have an average aspect ratio of at least 5.

In some aspects, the techniques described herein relate to a free particulate wherein the free particles have an average aspect ratio that is greater than or equal to 1.5 and less than 5.

In some aspects, the techniques described herein relate to a free particulate additionally including a conductive additive.

In some aspects, the techniques described herein relate to a free particulate wherein the conductive additive includes carbon.

In some aspects, the techniques described herein relate to a free particulate wherein the carbon is graphite.

In some aspects, the techniques described herein relate to a free particulate wherein the crystalline grains have a crystallographic strain less than 1%.

In some aspects, the techniques described herein relate to a free particulate wherein the crystalline grains are smaller than 200 nm.

In some aspects, the techniques described herein relate to a free particulate wherein the free particles are flakes that are greater than 80% by weight LiFePO₄, have an average flake diameter in a range from 5 μm to 50 μm, an average flake thickness in a range of 0.1 μm-10 μm, and an average aspect ratio of at least 5, and a surface area that is less than 8 m²/g.

In some aspects, the techniques described herein relate to a free particulate wherein the average flake diameter is in a range from 5 μm to 25 μm and the average flake thickness is in a range of 0.1 μm-5 μm.

In some aspects, the techniques described herein relate to a free particulate wherein the LiFePO₄ consists of grains with an average size less than 0.3 μm.

In some aspects, the techniques described herein relate to a free particulate wherein the free particles have a curvature with a radius of curvature in a range from 10 μm to 100 μm.

In some aspects, the techniques described herein relate to a free particulate wherein: the free particles are greater than 80% by weight LiFePO₄; the LiFePO₄ consists essentially of crystalline grains; the crystalline grains of LiFePO₄ have a preferred orientation in the [101] direction with respect to the major plane of the free particles with a preferred orientation parameter that is less than 0.98; and the free particles include carbon regions residing between the LiFePO₄ grains and the carbon regions are in a range between 0.1% to 10% by weight.

In some aspects, the techniques described herein relate to a free particulate wherein the carbon regions have an average size less than 100 nm.

In some aspects, the techniques described herein relate to a free particulate wherein the free particles are greater than 80% by weight NMC; the NMC consists essentially of crystalline grains; and the crystalline grains of NMC have a preferred orientation in the [110] direction with respect to the major plane of the free particles with a preferred orientation parameter that is greater than 1.02.

In some aspects, the techniques described herein relate to an electrode for an electrochemical cell including a porous electroactive coating on a current collector, the electroactive coating including greater than 80% by weight free particulate and a binder, wherein: the free particulate includes free particles described herein; the electrode coating has an electrode porosity that is less than 20%; and a loading of the electrode coating on the current collector is greater than mAh/cm². In some aspects, the techniques described herein relate to a lithium ion rechargeable battery including the aforementioned electrode.

In some aspects, the techniques described herein relate to an electrode wherein the free particulate includes carbon.

In some aspects, the techniques described herein relate to an electrode wherein the electrode coating has an electrode porosity that is less than 15%.

In some aspects, the techniques described herein relate to an electrode wherein the loading of the electrode coating on the current collector is greater than 3 mAh/cm².

In some aspects, the techniques described herein relate to an electrode for a lithium-ion electrochemical cell including a porous electroactive coating on a current collector, the electroactive coating including greater than 10% by weight free particles wherein: free particles are greater than 80% by weight crystalline grains of LiFePO₄; the free particles are flakes having an aspect ratio of at least 5, a flake diameter in a range from 5 μm to 50 μm, and a flake thickness in a range of 0.1 μm-10 μm; the free particles include carbon regions in a range between 0.1% to 10% by weight residing between the crystalline grains of LiFePO₄; the free particles have an internal porosity less than 20%; and the carbon regions have an average size less than 100 nm.

In some aspects, the techniques described herein relate to an electrode wherein the free particles are greater than 80% by weight LiFePO₄ and the crystalline grains of LiFePO₄ have a preferred orientation in the [101] direction with respect to the major plane of the free particles with a preferred orientation parameter that is less than 0.98.

### BRIEF DESCRIPTION OF THE DRAWINGS

FIG. 1a shows a schematic of the method steps according to some embodiments.

FIG. 1b schematically shows a mechanofusion system suitable for use in the modified microgranulation method according to some embodiments.

FIG. 2 shows a SEM image of the ZrO₂ template particles used in the Examples.

FIG. 3 shows a SEM image of a comparative particulate in the Examples.

FIG. 4 shows an X-ray diffraction pattern of the comparative particulate of FIG. 3.

FIG. 5 shows a SEM image of a cross section of an electrode coating prepared with the comparative particulate of FIG. 3.

FIG. 6 shows the voltage curve of the first two cycles of a lithium cell prepared with an electrode comprising the comparative particulate of FIG. 3.

FIG. 7 shows the polarization of the lithium cell of FIG. 6 plotted as a function of cycle number. For comparison, also shown is the polarization of the lithium cell of FIG. 19 comprising particulate of some embodiments.

FIG. 8 shows the capacities and coulombic efficiencies of the cells of FIG. 7 plotted as a function of cycle number.

FIG. 9 shows a SEM image of ZrO₂ template particles with a uniform coating of unheated LFP/carbon composite after 20 minutes of mechanofusion processing in accordance with some embodiments.

FIG. 10 shows a SEM image of the coated ZrO₂ template particles from FIG. 9 following impact milling.

FIG. 11 shows a SEM image of unheated LFP/carbon composite free flake particulate.

FIG. 12 an X-ray diffraction pattern of the unheated LFP/carbon composite free flake particulate of FIG. 11.

FIG. 13 shows a SEM image of the LFP/carbon composite free flake particulate from FIG. 12 after heating.

FIG. 14 shows an X-ray diffraction pattern of particulate IE1 made in the Examples.

FIG. 15 shows an SEM image of a single IE1 particle whose surface has been etched utilizing a focused gallium-ion beam.

FIG. 16 shows an SEM image of a single IE1 particle that has been cross-sectioned by a broad argon-ion beam, where the cross section is perpendicular to the flake basal plane.

FIG. 17 shows the same image as FIG. 16, excepting that lines of voids have been highlighted by black lines.

FIG. 18 shows a SEM image of a cross section of an electrode coating prepared with the IE1 particulate.

FIG. 19 shows the voltage curve of the first two cycles of a lithium cell prepared with an electrode comprising the IE1 particulate.

FIG. 20 compares the capacities of lithium half-cells prepared with electrodes comprising particulate IE1 and comparative particulate CE1 at various charge/discharge rates.

FIG. 21 shows an SEM image of particulate IE2.

FIG. 22 shows an XRD pattern of the particulate of Example IE2.

FIG. 23 shows a cross-section image of an electrode prepared with particulate IE2 as its active material.

FIG. 24 shows the discharge capacity vs. cycle number of cells utilizing particulate IE2 and comparative particulate CE1 cycled at different discharge rates as indicated.

FIG. 25 shows a SEM image of NMC622 particulate.

FIG. 26 shows a SEM image of NMC622 particulate coated onto ZrO₂ spheres.

FIG. 27 shows a SEM image of free flake NMC622 particulate.

FIG. 28 shows an XRD pattern of the free flake NMC622 particulate of FIG. 27.

FIG. 29 shows a SEM image of the free flake NMC622 particulate of Example IE3.

FIG. 30 shows an XRD pattern of the free flake NMC622 particulate of Example IE3.

FIG. 31 shows an SEM image of a BIB cross-section of the electrode coating of IE3.

FIG. 32 shows the voltage curve of a coin cell made with the free flake NMC622 particulate of Example IE3 as the active material in the working electrode.

FIG. 33 shows the capacity of the same cell shown in FIG. 31 plotted as a function of cycle number.

### DETAILED DESCRIPTION OF THE PREFERRED EMBODIMENT

It has been discovered that desirable free particulate consisting essentially of free particles (such as those comprising electroactive materials having the general formula AₓT_{y}M_{z}O₂ or AₓT_{y}PO₄, for use in lithium batteries and other applications) can be produced simply and quickly by methods involving a mechanofusing step followed by an impact milling step. In the general formula AₓT_{y}M_{z}O₂ or AₓT_{y}PO₄ x≥0, y≥0.5, and 0.2≥z≥0; A consists of one or more insertable alkali metals (in the case of Li-ion batteries is lithium); T consists of one or more first row transition metal elements; and M consists of one or more metal elements other than an alkali metal or a first-row transition metal element. In the mechanofusing step, suitable feedstock and template particles are subject to dry mechanofusion such that feedstock particles coat the template particles to form a coating. For example, mechanofusion may include the use of mechanical force such as high shear and/or high pressure to coat template particles with feedstock particles and may be a dry step without use of solvent. Then the latter impact milling step is used to break off the coating from the template particles, thereby forming free particles or free particulates comprising free particles (i.e., the particles are “free” from the template particles). Surprisingly, free particles produced by these methods can differ structurally from particles in the prior art in that they can have an inter-grain layered structure. Such a structure is evidenced by an atypical preferred orientation of the grains that the free particles are comprised of. Such free particles can have significantly lower surface areas than those made in the prior art. Further, electrodes can be made with such free particles that have significantly lower porosities and yet high loadings, while additionally providing surprisingly improved performance in electrochemical cells.

Also described are unique free particles made by methods and embodiments herein that are useful in electrochemical cells, such as lithium ion batteries. In some embodiments, the free particles comprise LFP, NMC and/or graphite. Such materials can enable extremely high electrode densities to be achieved at conventional calendering pressures. Simultaneously and unexpectedly, reactivity with electrolyte can be reduced, and cycle life and rate capability can be improved. The free particles can have average particle diameters ranging from 1-30 μm. In some embodiments the free particles are flakes and can have average particle thicknesses ranging from 0.1-10 μm with average aspect ratios of at least 5 (for example, ranging from 5-100). In some applications, the free particles can have average particle widths ranging from 5 μm-25 μm and average particle thicknesses ranging from 0.1 μm-5 μm with average aspect ratios ranging from 10-100. Further described are unique electrodes for electrochemical cells such as Li-ion (also referred to herein as “lithium-ion,” or “lithium ion”) batteries that incorporate the aforementioned free particles and methods. Such electrodes can have exceedingly high densities, while maintaining exceptionally high gravimetric capacity and low polarization.

### Method of Producing Free Particles

Some embodiments include a method of making highly dense free particles from smaller feedstock particles. In some embodiments, the method utilizes a combination of mechanofusion with template particles, impact milling, and particle separation (classification) steps.

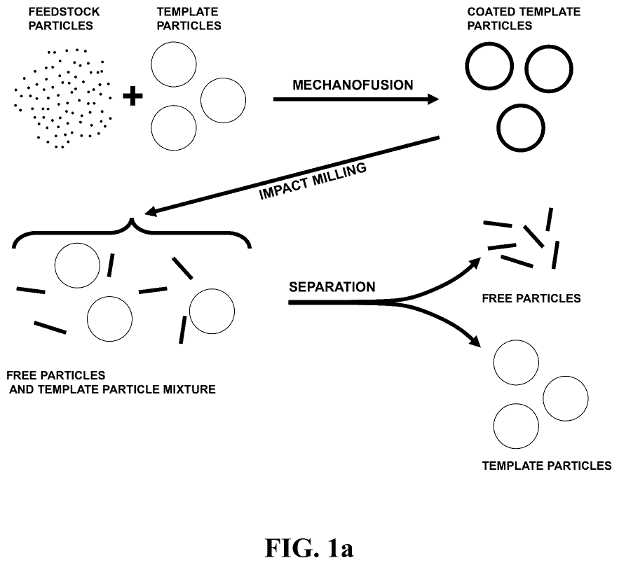

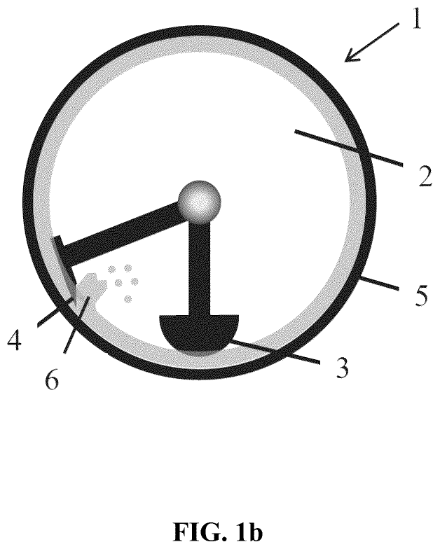

One aspect of the present disclosure involves a method of producing free particles, referred to herein as modified microgranulation or “MM”. The MM method is illustrated in FIG. 1a and comprises combining suitable feedstock particles and template particles into a mixture, mechanofusion processing the mixture until the feedstock powder forms a coating on the template particles, collecting the coated template particles, and subjecting them to impact milling such that some or all of the coating layer is broken off the template particles in the form of free particles (for example, flakes), thus forming a free particle and template particle mixture, and then subjecting the free particle and template particle mixture to a separating process that collects the free particles separate from the template particles.

In some embodiments, free particles or free particulates can be made by a method comprising the steps of: providing feedstock particles and template particles, dry mechanofusing the feedstock particles and the template particles such that feedstock particles coat the template particles to form coated template particles, impact milling the coated template particles such that the feedstock coating on the template particles break off the template particles to form broken off free particles (for example, flakes). In some embodiments, the feedstock coating may break off the template particles to form broken off free particulates comprised of free particles. Optionally, the method may further comprise separating the broken off free particles from the template particles, thereby obtaining the free particles. A free particulate may be comprised of two or more free particles and is free or substantially free of template particles.

Favorable template particles include those that are spherical, monodisperse, composed of a hard substance, and are chemically inert with respect to the feedstock particles, mechanofusion vessel, and processing atmosphere. Preferred template particles are those less than 200 μm in size. For example, the template particles may be less than 200 μm, less than 150 μm, less than 100 μm, less than 75 μm, less than 60 μm, less than 50 μm in size, or any range constructed from any of the aforementioned values. Generally, template particles should be greater than 5 μm in size or, more preferably, greater than 10 μm in size. In some embodiments, the template particles used can be spherically shaped and less than 200 μm in diameter, i.e., significantly smaller than the balls used in ball milling. Exemplary template particles include those composed of ZrO₂. In some embodiments, the template particles have an average particle size of 50 μm.

Favorable feedstock particles are smaller than the average template particle size. Preferred feedstock particles have an average particle size that is less than 1/10^{th} of the average template particle size, less than 1/50^{th} of the average template particle size, less than 1/100^{th} of the average template particle size or even smaller. In some embodiments exemplary feedstock particles have an average particle size of 1 μm and are used with template particles that have an average particle size of 50 μm. In some embodiments exemplary feedstock particles have an average particle size of 0.5 μm and are used with template particles that have an average particle size of 50 μm. In some embodiments the feedstock particles may be larger than 1/10^{th} of the average template particle size but become reduced to less than 1/10^{th} of the average template particle size during the initial stages of the MM process.

The feedstock particles can comprise an electroactive material for a rechargeable battery such as a Li-ion battery. The electroactive material feedstock composition for use in rechargeable batteries can have the general formula AₓT_{y}M_{z}O₂ or AₓT_{y}M_{z}PO₄ in which x, y and z are numbers with x≥0, y≥0.5, and z≥0; y+z=1; A is one or more insertable alkali metals; T is one or more first row transitional metals; and M is a dopant that consists of one or more metal elements that are not an alkali metal or a first-row transition metal. In some embodiments, x, y, and z are numbers with 1.2≥x≥0.9, 1≥y≥0.9, and 0.1≥z≥0. In the case of Li-ion batteries, A is lithium. In some embodiments electroactive materials having the formula AₓT_{y}M_{z}O₂ have an α-NaFeO₂ type structure. In some embodiments electroactive materials having the formula AₓT_{y}M_{z}PO₄ have an olivine-type structure. In some embodiments, the feedstock particles may further comprise graphite. In some embodiments the feedstock materials are compositionally the same as the electroactive cathode material produced through processes herein.

For the electroactive material represented by the general formula AₓT_{y}M_{z}O₂, discussed above, T may consist of one or more first-row transition metals; and M is a dopant consisting of a metal element that is not an alkali metal or a first-row transition metal. In some embodiments, an air stable version of the transition metal oxide can be employed for ease of manufacturing. In these embodiments, x is typically equal to about 1 and y+z is about 1, and z is greater than or equal to 0. In some embodiments, x is equal to 1 and y+z is 1, and z is greater than or equal to 0. In some embodiments, x is about 1, y+z is about 1, and z is less than about 0.1. In some embodiments, x is 1, y+z is 1, and z is less than 0.1. Optionally, z may be 0 where no dopant is present.

In some embodiments with the electroactive material represented by the general formula AₓT_{y}M_{z}O₂, discussed above, T consists of one or more first-row transition metals comprising cobalt (Co), nickel (Ni), or manganese (Mn). In some embodiments, T is selected from a group consisting of Co, Ni, and Mn. In some embodiments, T is selected from a group consisting of Ni and Mn. In other embodiments, T consists of only Co. In some embodiments, M is selected from a group consisting of one or more of Mg, Al, Ti, Zr, W, Zn, Mo, K, Na, Si, Nb, and Ta, when z is greater than 0.

In some embodiments with the electroactive material represented by the general formula AₓT_{y}M_{z}O₂, discussed above, T may include Ni, Mn, and Co (such as a material known as “NMC”). The NMC may be LiₓNi_{f}Mn_{g}CoₕO₂, having an α-NaFeO₂ structure, and where x is about 1; f, g and h are all greater than zero; and f+g+h=about 1. An example includes LiNi_{0.6}Mn_{0.2}Co_{0.2}O₂. In some embodiments, NMC can further comprise small amounts of dopant elements M. For example, LiₓNi_{f}Mn_{g}COₕM_{z}O₂, wherein M is selected from a group consisting of one or more of Mg, Al, Ti, Zr, W, Zn, Mo, K, Na, Si, Nb, and Ta; and z is greater than 0, but less than 0.1.

In some embodiments with the electroactive material represented by the general formula AₓT_{y}M_{z}O₂, discussed above, the feedstock particles may include so-called “Co-free NMC” materials that have a composition of LiₓNiⱼMnₖM_{z}O₂, having an α-NaFeO₂ structure, and in which x is about 1, j+k+z=about 1, z<0.1, and M includes one or more dopant elements (for example, Mg, Al, Ti, Zr, W, Zn, Mo, K, Na, Si, Nb, or Ta). In some embodiments, x is 1, j+k+z=1, and z<0.1. In some embodiments, the feedstock particles may have a composition of LiMn₂O₄.

In some embodiments with the electroactive material represented by the general formula AₓT_{y}M_{z}O₂, discussed above, T comprises Ni and Co, and M consists of one or more of Mg, Al, Ti, Zr, W, Zn, Mo, K, Na, Si, Nb, or Ta. In some embodiments, M is aluminum (for example, a material known as “NCA”). In some embodiments, T may include only Co, for example, LiCoO₂ (LCO). In some embodiments, LCO may further comprise one or more dopants M.

For the electroactive material feedstock composition represented by the general formula AₓT_{y}M_{z}PO₄ discussed above, A may be Li, T may consist of one or more first-row transition metals, x is equal to about 1, y is about 1, and z<0.1. In some embodiments, T is Fe. In some embodiments, T is Mn. In some embodiments, T includes Mn and Fe. In some embodiments, M may consist of one or more of Mg, Al, Ti, Zr, W, Zn, Mo, K, Na, Si, Nb, and Ta when z is greater than 0. In some embodiments, the feedstock particles may include LiFePO₄ (“LFP”). In some embodiments, the feedstock particles can comprise LiFePO₄ and graphite in which case the free particles produced comprise a blend of LiFePO₄ and graphite. In some embodiments, the feedstock particles can comprise lithium manganese phosphate (LMP) or lithium manganese iron phosphate (LMFP).

The amounts of feedstock particles and template particles employed in the method may be chosen such that an approximate desired feedstock coating thickness on the template particles would be achieved. For instance, these amounts may be chosen such that the ratio of the true volume of feedstock particles to the surface area of the template particles corresponds to a feedstock coating thickness of 0.1 μm-50 μm, 0.1 μm-40 μm, 0.1 μm-20 μm, or 0.1 μm-10 μm. For example, the feedstock coating thickness may be 0.1 μm, 1 μm, 15 μm, 20 μm, 25 μm, 30 μm, 35 μm, 40 μm, 45 μm, 50 μm, or a range constructed from any of the aforementioned values. The true volume of feedstock particles may be determined from their true density, which can be obtained from x-ray diffraction measurements or from pycnometry measurements.

When the free particles produced are flakes, the flakes can be non-planar and have a curvature. This curvature can be imparted on the flake particles from the surface curvature of the template particles. Therefore, it may be desirable to use larger template particles if it is desirable to reduce the curvature of the flakes. However utilizing template particles that are too large may interfere with the flow of particles through the press-head gap during the mechanofusion step. A template particle radius that is less than 200 μm in size is generally preferred.

In some embodiments, mechanofusion (also known as “MF”) is a dry process producing high shear and/or high pressure fields. Mechanofusion may advantageously be relatively simple and inexpensive. For example, in embodiments which include a dry process, no solvents are required thereby making it potentially attractive for environmentally responsible commercial manufacture. FIG. 1b schematically shows a suitable MF system 1 for use in the method of some embodiments. It comprises rotating cylindrical chamber 2 in which fixed rounded press-head 3 and fixed scraper 4 are placed. The radius of press-head 3 is smaller than that of chamber 2 and the clearance space between press-head 3 and chamber wall 5 generally ranges from 1 to 5 mm. The clearance between scraper 4 and chamber wall 5 is smaller, usually around 0.5 mm. Preferably these clearances are adjustable for optimization, depending on factors such as the chamber size, particle size, powder hardness, and so on.

Operation of MF system 1 is simple. In use, particle mixture 6 is placed into the chamber and chamber 2 is sealed. When the chamber rotates, particle mixture 6 is forced to chamber wall 5 by centrifugal action. This also forces the particle mixture to pass through the converging space between fixed press-head 3 and rotating chamber wall 5, establishing a high-shear and high pressure field. As the particles come out of the diverging space of the press-head region, they adhere to each other and to the chamber wall. Scraper 4 serves to scrape off the particle mixture 6 attached to chamber wall 5. The sheared particle mixture is then re-dispersed into the chamber and moves towards the press-head region again. Appropriate operating parameters for the MF system can be expected to vary according to the differences in the types and amounts of the particles employed and the ultimate desired characteristics of the free particulate to be produced. It is expected that those of ordinary skill will readily be able to determine appropriate operating parameters for a given situation based on guidance from the present disclosure. A representative mechanofusing time thus can be in the range from 30 seconds to 5 hours. For example, the mechanofusing time may be 10 seconds, 30 seconds, 1 minute, 5 minutes, 10 minutes, 30 minutes, 1 hour, 2 hours, 3 hours, 4 hours, 5 hours, 6 hours, or a range constructed from any of the aforementioned values.

In other embodiments, mechanofusion may include other processes known to fuse small particles onto large particles. For instance, in some embodiments a Hybridizer (e.g. as manufactured by Nara Machinery of Japan), magnetically assisted impaction coating, or a theta composer may be used to accomplish the mechanofusion step. In some embodiments methods described in [Robert Pfeffer, Rajesh N. Dave, Dongguang Wei, Michelle Ramlakhan, Synthesis of engineered particulates with tailored properties using dry particle coating, Powder Technology 117 (2001) 40-67] may be utilized to accomplish the mechanofusion step.

In some instances, the feedstock particles may have poor adhesion to each other and to the template particles and the MM processing may be difficult to accomplish. To improve the adhesion of feedstock particles to each other and to template particles, an adhesion promoter in the form of a solvent and/or a binder may be included with the feedstock powder and template particle mixture prior to the mechanofusion processing step. Suitable solvents may include mineral oil, poly(vinyl alcohol) (PVA), n-methyl-2-pyrrolidone (NMP), propylene glycol, and water. Suitable binders may include polymers, such as polyvinylidene difluoride (PVDF), carboxymethyl cellulose (CMC), polyacrylic acid (PAA), and polytetrafluoroethylene (PTFE), polyethylene (PE), and polypropylene (PP). Other suitable binders include pitch, phenolic resin, and polyacrylonitrile.

In some instances, only a solvent may be used as adhesion promoter. In some instances, only a binder may be used as an adhesion promoter. For instance, a binder in powder form may be used as an adhesion promoter. In some instances, binders dissolved in a solvent may be used as an adhesion promoter, such as solutions of PVDF in NMP, CMC in water, or PAA in water. In some embodiments, a method to combine the adhesion promoter with the feedstock particulate may be employed prior to the MM mechanofusion step. Such methods include applying ball milling, vibratory milling, planetary milling or other communition or blending methods to a mixture of adhesion promoter and feedstock particulate. In some embodiments, the use of an adhesion promoter is effective in enabling the feedstock particles to adhere to each other and to the template particles, thus enabling the production of free particles by the MM process. In some embodiments the produced free particles may comprise the feedstock particulate only (for example, when the adhesion promoter evaporates during the MM process), and the MM process may be a substantially dry process. However, more generally, the produced free particles comprise the feedstock particulate and the adhesion promoter. This may be desirable in the final product. In some instances, the adhesion promoter may be removed from the product free particles by additional processing (for example, heating). In some embodiments, the utilization of excessive amounts of adhesion promoter may cause the feedstock particles to form a paste or to otherwise undesirably aggregate. Therefore, it is often desirable to use the least amount of adhesion promoter that enables free particle production by MM processing. In some embodiments, the use of adhesion promoter in an amount that is 20 wt %, 10 wt %, 5 wt %, or 2 wt % (or a range constructed from any of the aforementioned values) of the feedstock particulate amount or less may be effective in enabling free particle production by MM processing.

The impact milling step includes processes that subject the coated template particles to impacts or collisions to affect the breaking off of the template particle coating in the form of free particles (for example, flakes), but without overly damaging the resulting free particles (or template particles). Damage to the free particles during this process can cause them to break up into fine particles, which is undesirable in some embodiments, since this may result in free particulate with high surface area or low packing efficiency. Some preferred impact milling methods include jet milling, pin milling, and centrifugal impact milling and variations thereof. Impact milling processes that include a classification (separation) step that removes and collects free particles as they are produced are particularly advantageous. At small laboratory scales, impact milling may be conducted using a kitchen blender or coffee grinder. A representative impact milling time can be in the range from 5 seconds to 1 minute. For example, the impact milling time may be 2 seconds, 5 seconds, 10 seconds, 20 seconds, 30 seconds, 40 seconds, 50 seconds, 1 minute, 1 minute 30 seconds, 2 minutes, or a range constructed from any of the aforementioned values. Various techniques for impact milling known to those skilled in the art may be employed with some of the embodiments disclosed herein, such as centrifugal impact milling.

It is desirable that the product free particulate does not contain template particles. Therefore, a separation step that collects the broken off free particles separate from the template particles can be utilized. The separation process includes particle classification processes. Particularly useful methods for the separation step are cyclone air classification and sieving.

In some embodiments, it may be useful to perform additional processing steps on the product free particles of the MM process. For instance, in some instances, the MM process may introduce crystal defects. In some instances, it may be desirable to perform a final heating step under a controlled atmosphere to improve the crystallinity of the product free particles. In other instances, it may be desirable to react the product free particles chemically with other reagents. For example, it is expected that in the synthesis of free particle NMC by the MM method, MM processing of a mixed transition metal hydroxide may be performed to produce mixed metal hydroxide free particles, which can be subsequently ground with a suitable amount of lithium source (such as Li₂CO₃) and heated in an oxygen containing atmosphere (such as air or pure oxygen) to produce free NMC particles. In some embodiments, the final heating step may also be used to react the free particles and the free particulates with a lithium source (for example, Li₂CO₃ or LiOH).

In some embodiments a final heating step is performed on the free particulate to produce an electroactive material. In some embodiments, the final heating step may be one in which the free particulate is heated under an inert gas atmosphere, such as N₂ or Ar. In some embodiments, the final heating step may be one in which the free particulate is heated under an oxygen containing atmosphere, such as O₂ or air. In some embodiments, the final heating step may be one in which the free particulate is heated under a reducing atmosphere, such as H₂ or an H₂/N₂ mixture. In some embodiments, the final heating step may be one in which the free particulate is heated under vacuum. Generally, the temperature used in the final heating step is greater than 200° C. In some embodiments, especially for cathode materials, the temperature used during the final heating step may be in the range of 500° C. to 1200° C. The time duration of the final heating step is typically in the range between 30 minutes and 1 week and more typically in the range between 1 hour and 24 hours. In some embodiments, the final heating step may include many individual heating steps, in which the free particulate is heated under different atmospheres at different temperatures and for different times. The final heating of free particles for a cathode material can convert the free particles into an electroactive cathode material.

In some embodiments the feedstock particles comprise compounds which can form electroactive material for a rechargeable battery, such as a Li-ion battery, upon heating. The free particulate formed after MF, impact milling, and separation (which is free or substantially free of template particles) may then be heated in a final heating step to form free electroactive material particulate. As an example, the feedstock particles may comprise a Ni—Mn—Co hydroxide, resulting in the formation of free particulate comprising Ni—Mn—Co-hydroxide. The free particulate comprising Ni—Mn—Co-hydroxide may then be heated in a final heating step (for example, at 700° C.-900° C. in air or oxygen for 1 hour-24 hours) with a lithium source (for example, Li₂CO₃ or Li(OH)) to form free NMC particulate. In other embodiments, the feedstock particles may comprise a mixture of Ni, Mn, or Co oxides and free particulate comprising Ni—Mn—Co-oxide may be produced, which may combine with a lithium source and heated in a final heating step to form free NMC particulate in a similar manner. In other embodiments, the feedstock particles may comprise metal phosphates, so that free particulate comprising metal phosphates may be produced. In some embodiments free particulate comprising metal phosphates may be heated in a final heating step to produce free LFP particulate or free LMFP particulate.

The method disclosed herein can be used to quickly prepare free particle or free particulate materials. In the examples below, batch processes may be employed and the successful mechanofusing and impact milling times may be of the order of minutes. However continuous processes may be considered for either or both steps and thus these times can vary accordingly.

The methods disclosed herein can be used to make novel free particles/free particulates and electrodes therefrom that can have unexpectedly advantageous characteristics. Further, the methods described herein are environmentally friendly and advantageous for industrial use because of the elimination of the use of solvents and for many other reasons.

As those skilled in the art will further appreciate, it is expected that many other related free particulate materials may be made using the methods disclosed herein, for example, LiNi_{f}Mn_{g}CoₕO₂, where f, g and h are all greater than zero and f+g+h=1 (or NMC) free particulate, flake NMC free particulate, LCO free particulate, NCA free particulate, NMC/carbon free particulate, and similar such materials.

In further embodiments, the methods disclosed herein can be utilized to make free particulate electroactive materials for battery chemistries, such as Na-ion, K-ion, Mg, and rechargeable battery chemistries. As an example, for the synthesis of electroactive materials for rechargeable Na-ion and K-ion batteries, the free particulate materials can comprise an electroactive material for a Li-ion of K-ion battery having the general formula AₓT_{y}M_{z}O₂ or AₓT_{y}M_{z}PO₄ in which x, y and z are numbers with x≥0, y≥0.5, and z≥0; x, y, and z are numbers with 0≤x≤1.2, 0.5≤y≤1, and 0≤z≤0.2; y+z=1; A is one or more insertable alkali metals; T is one or more first row transitional metals; and M is a dopant that consists of one or more metal elements that are not an alkali metal or a first-row transition metal. In the case of Na-ion batteries, A is sodium. In the case of K-ion batteries, A is potassium. In some embodiments electroactive materials having the formula AₓT_{y}M_{z}O₂ have an α-NaFeO₂ type structure. In some embodiments electroactive materials having the formula AₓT_{y}M_{z}PO₄ have an olivine-type structure. In some embodiments, the feedstock particles may further comprise amorphous graphite.

### Free Particulate

Another aspect of the present disclosure is unique free particulate for use in cathodes or anodes for electrochemical cells such as Li-ion batteries. Such free particulate and electrodes made therefrom can have unexpectedly advantageous characteristics. For instance, free particulate can comprise free flake particles with surprisingly low surface areas (for example, less than 8 m²/g or even less than 6 m²/g). As demonstrated in the following examples, cathodes incorporating LFP-graphite composite flake particulate can be prepared with desirable loadings and have been found to achieve exceptional coating densities at low calendering pressures while also exhibiting superior electrochemical performance. It has been found that the microstructure of such novel free particles may be unique, and the free particulate may be particularly useful as active materials for Li-ion batteries.

In some embodiments, the free particulate comprises free particles that comprise greater than 80% by weight of a metal oxide or a metal phosphate electroactive phase. For example, in some embodiments, the free particles are greater than 80% by weight LiFePO₄. For example, in other embodiments, the free particles in the free particulate may be greater than 80% by weight NMC. In some embodiments, the free particles comprise more than 80%, more than 85%, more than 90%, or more than 95% by weight of a metal oxide or a metal phosphate electroactive phase (including, for example, crystalline grains of a metal oxide or a metal phosphate electroactive phase). In some embodiments the free particles consist of 100% by weight of a metal oxide or a metal phosphate electroactive phase. In some embodiments the electroactive phase is for use in a rechargeable battery such as a Li-ion battery. In some embodiments the electroactive phase can have the general formula AₓT_{y}M_{z}O₂ or AₓT_{y}M_{z}PO₄ in which x, y and z are numbers with x≥0, y≥0.5, and z≥0; x, y, and z are numbers with 0≤x≤1.2, 0.5≤y≤1, and 0≤z≤0.2; y+z=1; A is one or more insertable alkali metals; T is one or more first row transitional metals; and M is a dopant that consists of one or more metal elements that are not an alkali metal or a first-row transition metal. In the case of Li-ion batteries, A is lithium. In some embodiments the electroactive phase having the formula AₓT_{y}M_{z}O₂ has an α-NaFeO₂ type structure. In some embodiments the electroactive phase having the formula AₓT_{y}M_{z}PO₄ has an olivine-type structure.

In some embodiments, the free particulate comprises free particles having a density greater than 3 g/ml. In some embodiments, the free particles have a density greater than 3 g/ml, 4 g/ml, 5 g/ml, 6 g/ml, or more.

In some embodiments, the free particulate comprises free particles having an average particle size in the range from 1 to 30 μm. In some embodiments, free particulates comprise free particles having an average size that is in the range between 5 μm and 30 μm. In embodiments, the free particles may have an average size ranging from 0.5 μm, 1 μm, 2 μm, 5 μm, 10 μm, 15 μm, 20 μm, 25 μm, 30 μm, 40 μm, or a range constructed from any of the aforementioned values.

In some embodiments, the free particles have an average internal porosity less than 20%. In some embodiments, the free particles have internal porosities less than 10%, less than 5%, or even less than 2%. For example, free particulates can comprise constituent free particles that have an average internal porosity of less than 20%, for example 20%, 19%, 18%, 17%, 16%, 15%, 14%, 13%, 12%, 11%, 10%, 9%, 8%, 7%, 6%, 5%, 4%, 3%, 2%, 1%, substantially 0%, or a range constructed from any of the aforementioned values.

In some embodiments, the volumetric surface area of the free particles is less than 30 m²/ml. In some embodiments, a volumetric surface area is less than 30 m²/ml, less than 29 m²/ml, less than 28 m²/ml, less than 27 m²/ml, less than 26 m²/ml, less than 25 m²/ml, less than 24 m²/ml, less than 23 m²/ml, less than 22 m²/ml, less than 21 m²/ml, less than 20 m²/ml, less than 19 m²/ml, less than 18 m²/ml, less than 17 m²/ml, less than 16 m²/ml, less than 15 m²/ml, less than 14 m²/ml, less than 13 m²/ml, less than 12 m²/ml, less than 11 m²/ml, less than 10 m²/ml, less than 9 m²/ml, less than 8 m²/ml, less than 7 m²/ml, less than 6 m²/ml, less than 5 m²/ml, less than 4 m²/ml, less than 3 m²/ml, or less than 2 m²/ml, or is a range constructed from any of the aforementioned values. In some embodiments, the free particles have a surface area that is less than 8 m²/g. In some embodiments, the free particles have a surface area that is preferably less than 6 m²/g. In some embodiments free particles have low specific surface areas, i.e. that are less than 20 m²/g, less than 10 m²/g, less than 8 m²/g or even smaller. In some embodiments such free particles have lower volumetric surface areas, i.e. less than 20 m²/ml, less than 15 m²/ml, less than 8 m²/ml or even smaller.

In some embodiments free particles have a flake morphology. In some embodiments, the free particulate has an average flake diameter in the range from 5 to 50 μm. In some embodiments, the average flake diameter is in the range from 5 to 25 μm. In some embodiments, the average flake diameter is between 5 to 50 μm, for example 5 μm, 10 μm, 15 μm, 20 μm, 25 μm, 30 μm, 35 μm, 40 μm, 45 μm, 50 μm, or a range constructed from any of the aforementioned values. In some embodiments, the free particles have an average flake thickness in the range of 0.1 to 10 μm. In some embodiments, the average flake thickness is in the range of 0.1 to 5 μm. In some embodiments, average flake thickness is between of 0.1-10 μm, for example 0.1 μm, 0.5 μm, 1 μm, 1.5 μm, 2 μm, 3 μm, 4 μm, 5 μm, 6 μm, 7 μm, 8 μm, 9 μm, 10 μm, or a range constructed from any of the aforementioned values.

In some embodiments, the average aspect ratio of the free particles is greater than 1.5. In some embodiments, the free particles can have an average aspect ratio of at least 5. In some alternative embodiments, the average aspect ratio is in the range from greater than or equal to 1.5, and less than 5. In some embodiments, the average aspect ratio of the free particles is 1.5, 2, 2.5, 3, 3.5, 4, 4.5, 5, 5.5, 6, 6.5, 7, 7.5, 8, 8.5, 9, 9.5, 10, or greater, or a range constructed from any of the aforementioned values. In some embodiments, free particulates comprise free particles having a flake morphology with an aspect ratio of at least 5. In some embodiments, free particulates comprise free particles having a substantially oblong or potato-like morphology with an aspect ratio that is greater than or equal to 1.5 and less than 5.

In some embodiments, the free particles comprise a curvature. In some embodiments, the radius of curvature in the range from 10 to 100 μm. In some embodiments, the radius of the curvature is 10 μm, 20 μm, 30 μm, 40 μm, 50 μm, 60 μm, 70 μm, 80 μm, 90 μm, or 100 μm, or a range constructed from any of the aforementioned values.

In some embodiments, the free particulate comprises free particles that are comprised of greater than 80% by weight crystalline grains between 20 nm and 300 nm in size. In some embodiments the free particles of the free particulate comprise metal oxide or metal phosphate grains. In some embodiments, crystalline grains in the free particles have a crystallographic strain less than 1%, for example less than 0.8%, less than 0.5%, less than 0.3%, less than 0.1%, less than 0.01%, or even less, or a range constructed from any of the aforementioned values.

In some embodiments, the crystalline grains are smaller than 200 nm in size. In some embodiments, the free particles have internal microstructure that is comprised of greater than 80% by weight crystalline grains that are 10 nm, 20 nm, 30 nm, 40 nm, 50 nm, 60 nm, 70 nm, 80 nm, about 90 nm, 100 nm, 110 nm, 120 nm, 130 nm, 140 nm, 150 nm, 160 nm, 170 nm, 180 nm, 190 nm, 200 nm, 210 nm, 220 nm, 230 nm, 240 nm, 250 nm, 260 nm, 270 nm, 280 nm, 290 nm, 300 nm, or a range constructed from any of the aforementioned values, in size. In some embodiments, the grains have an average size less than 0.3 μm. In some embodiments, the crystalline grains consist of LiFePO₄.

In some embodiments, free particles comprise inter-grain layers in which the electroactive phase therein has a preferred crystal orientation with respect to those inter-grain layers. In some embodiments, the crystalline grains are furthermore arranged in inter-grain layers that are generally parallel to each other. In some embodiments, lamellar arrangements of grains, voids, or of cracks in the free particles may also be observed, for instance in SEM images of free particle cross sections (for example, with a repeat distance of less than 600 nm). The average distance between these lamellar arrangements in the free particles may be referred to as the inter-grain layer thickness. The presence of such inter-grain layers can be detected and confirmed by the presence of preferred orientation in a sample of the free particulate as measured by x-ray diffraction. In some embodiments, a preferred orientation parameter of more than 1.02 or less than 0.98 may be indicative that the grains that make up the free particles are preferentially aligned with the face of the largest dimension of the particles, which may be indicative that the grains are arranged in inter-grain layers.

In some embodiments, the metal oxide and/or metal phosphate grains in the free particles have a preferred orientation with respect to the major plane of the particles with a preferred orientation parameter that is greater than 1.02 or less than 0.98. For example, in some embodiments, the crystalline grains (for example, of LiFePO₄) have a preferred orientation in the [101] direction with respect to the major plane of the free particles with a preferred orientation parameter that is less than 0.98, less than 0.97, less than 0.96, less than 0.95, less than 0.94, less than 0.93 or even smaller (or a range constructed from any of the aforementioned values). For another example, in other embodiments, the crystalline grains (for example, of NMC) have a preferred orientation in the [110] direction with respect to the major plane of the free particles with a preferred orientation parameter that is greater than 1.02, greater than 1.03, greater than 1.04, or even greater (or a range constructed from any of the aforementioned values).

In some embodiments, the free particles may additionally comprise a conductive additive, such as a carbon (for example, graphite). The conductive additive may be amorphous or non-crystalline, such as with graphite. For example, in some embodiments, a conductive additive is located between the inter-grain layers. In some embodiments the conductive additive is an inactive phase. For example, in some embodiments, the free particles comprise carbon regions in a range between 0.1 to 10% by weight residing between the crystalline grains (for example, LiFePO₄ grains). For example, the conductive additive (such as carbon regions) may comprise 0.1%, 0.2%, 0.5%, 1,%, 1.5%, 2%, 3%, 4%, 5%, 6%, 7%, 8%, 9%, 10%, by weight, or a range constructed from any of the aforementioned values. In some embodiments, these carbon regions have an average size less than 100 nm. In some embodiments, the regions of the conductive additive (such as carbon regions) have an average size less than 100 nm, for example 90 nm, 80 nm, 70 nm, 60 nm, 50 nm, 40 nm, 30 nm, 20 nm, 10 nm, or less, or a range constructed from any of the aforementioned values.

Free particles may have any combination of the features described herein. For example, some embodiments relate to free particulates comprising free particles that comprise more than 80% by weight of crystalline grains of a metal oxide or a metal phosphate electroactive phase, have a density greater than 3 g/ml, and an average particle size in the range from 1 to 30 μm. In some embodiments, free particles have a unique internal microstructure that is comprised of greater than 80% by weight crystalline grains between 20 nm and 300 nm in size.

In some embodiments, the novel free particulate of some embodiments herein comprises free particles of electroactive material wherein each free particle comprises greater than 80% by weight of a metal oxide or a metal phosphate electroactive phase, have a density greater than 3 g/ml, an average particle size in the range from 1 to 30 μm, and in which the free particles are comprised of greater than 80% by weight crystalline grains between 20 nm and 300 nm in size. In some embodiments the free particulate comprises: metal oxide or metal phosphate grains in the free particles that have a preferred orientation with respect to the major plane of the particles with a preferred orientation parameter that is greater than 1.02 or less than 0.98; the free particles have an average internal porosity less than 20%; the volumetric surface area of the free particles is less than 30 m²/ml; and the average aspect ratio of the free particles is greater than 1.5.

In some embodiments the constituent particles of the free particulates can comprise an electroactive phase suitable for use in battery applications. In the case of electroactive phases suitable for use in cathode materials, particularly exemplary cathode electroactive phases include LFP or other lithium transition metal phosphates, including lithium manganese phosphate (LMP) or lithium manganese iron phosphate (LMFP). Further particularly exemplary cathode active phases include disordered rock salt lithium transition metal oxides. Without being bound by theory, one reason the aforementioned cathode active phases are particularly exemplary may be that they are robust against reduction, especially when heated in an inert or reducing atmosphere and in combination with conducting additives such as graphite or other carbonaceous materials. Other exemplary cathode active phases include lithium transition metal oxides, such as LCO, NMC, NCA or LiMn₂O₄. In some useful embodiments the constituent particles of the free particulates additionally consist of a conducting additive.

Further examples of specific embodiments of electroactive free particulates are those consisting essentially of composite free particles that comprise an electroactive phase and a conducting additive in which the electroactive phase grains are less than 200 nm in size and in which the active phase grains are arranged preferentially in active phase inter-grain layers, each having a thickness that is less than 500 nm. In embodiments in which the free particles have a flake shape, the active phase inter-grain layers are parallel to the flake basal plane. In some embodiments, the conducting additive resides between the electroactive phase inter-grain layers, forming thin conducting additive layers between the electroactive phase inter-grain layers, having a thickness less than 100 nm. In some embodiments, the conducting additive may reside between the electroactive phase inter-grain layers, forming small conducting additive regions between the electroactive phase inter-grain layers, having a size that is less than 100 nm. In some embodiments the small conducting additive regions may be roughly spherical in shape.

In particularly advantageous embodiments having electroactive free particulates, LFP is the electroactive phase and a carbonaceous material, such as graphite, is the conducting additive. In such embodiments LFP/carbonaceous material weight ratios of 99.5:0.5 to 95:5 are particularly useful. Particularly useful embodiments of electroactive free particulates are free particulates consisting essentially of LFP/carbonaceous material composite free particles in which the LFP is composed of crystalline grains that are 50 nm to 200 nm in size and are arranged preferentially in LFP inter-grain layers that are less than 500 nm in thickness. In some embodiments of electroactive free particulates, the conducting additive is graphite and resides between the LFP inter-grain layers. In some embodiments of electroactive free particulates, the LFP grains may be preferentially oriented in the [101] direction with respect to the LFP inter-grain layers and have a preferred orientation parameter that less than 0.98, less than 0.97, less than 0.96, less than 0.95, less than 0.94, less than 0.93 or even smaller. In some embodiments of electroactive free particulates, the LFP may have low lattice strain that is less than 1%, less than 0.5%, less than 0.1% or even smaller. It is believed that such low lattice strain values indicate a high degree of crystallinity, which better enables lithium diffusion in the LFP grains. Not being bound by theory, it is further believed that the LFP preferential orientation allows for fast diffusion from the inside of LFP grains to their grain boundary, while the presence of carbon between the LFP inter-grain layers allows for fast lithium diffusion between the inter-grain layers and for electrical conduction. In such embodiments of electroactive free particulates, the free particles making up the particulate may have a flake shape, an oval shape, an ellipsoid shape, an ovoid shape, a potato shape or a roughly spherical shape. An example of this embodiment is an LFP/carbon free particulate where the LFP/carbon weight ratio is 98:2, the free particulate BET surface area is less than 8 m²/g, the internal porosity of the free particles making up the free particulate is less than 2%, the average LFP grain size is between 50 nm and 200 nm, the LFP crystallographic strain is less than 0.1%, the LFP grains are arranged preferentially in LFP inter-grain layers that are less than 500 nm in thickness, carbon resides between the LFP inter-grain layers, the LFP grains have a preferred orientation in the [101] direction with respect to the LFP inter-grain layers and with respect to the major planes of the free particles, the LFP grains have a preferred orientation parameter than is less than 0.98, and free particles making up the free particulate have a characteristic flake morphology with a flake width of 10 μm-20 μm and a flake thickness of 2 μm-5 μm. As an example of another embodiment, all the preceding aspects of the LFP/carbon free particulate are the same excepting that the free particles have a substantially oblong or potato-like shape with an average particle size between 5 μm and 30 μm.

Flake particulate can comprise free flake particles that are greater than 80% by weight LiFePO₄ and have a density greater than 3 g/ml, an average flake diameter in the range from 5 to 25 μm, an average thickness in the range of 0.1-5 μm, an average aspect ratio of at least 5, and surprisingly which also have a surface area that is less than 8 m²/g or even less than 6 m²/g. Further, in embodiments of such free flake particulate, the LiFePO₄ can consist of grains with an average size less than 0.3 μm. Further still, such particulate can comprise carbon, for example, graphite. In some embodiments the presence of graphite in a free flake particulate can be detected by the presence of one or more XRD peaks characteristic of graphite in its XRD pattern, especially the graphite (002) peak. And yet further, such free flake particles can have a curvature with a radius of curvature in the range from 10 μm to 100 μm. As demonstrated in the following Examples, cathodes incorporating LFP-graphite composite free flake particulate can be prepared with desirable loadings and have been found to achieve exceptional coating densities at low calendering pressures while also exhibiting superior electrochemical performance.

As those skilled in the art will expect that other similarly unique and useful materials may also be possible to make using the method of some embodiments herein, in particular cathode and anode free particulates comprising anode or cathode electroactive phases. Exemplary electroactive anode phases for use in Li-ion batteries include graphite, Li₅Ti₄O₁₂, silicon, silicon-carbon composites, silicon alloys, silicon suboxides, and combinations thereof. Exemplary electroactive cathode phases for use in Li-ion batteries include LCO, NMC, LFP, and LiMn₂O₄, and combinations thereof. Anode and cathode electroactive phases for use in Na-ion batteries may also be employed. Particularly useful embodiments of cathode and anode free particulates include those in which anode or cathode electroactive phase or phases comprise more than 80%, more than 90%, more than 95%, more than 98%, more than 99% or even 100% of the free particulate composition or any range between the aforementioned values.

In other particularly useful embodiments of electroactive free particulates NMC is the active phase, and no conducting additive is included in the free particulate composition. In some embodiments, the NMC grains may be preferentially oriented in the direction with respect to the major plane of the NMC free particles and have a preferential orientation parameter that is greater than 1.02, greater than 1.03, or even greater. In some embodiments, the NMC may have low lattice strain that is less than 1%, less than 0.5%, less than 0.1% or preferentially even smaller.

Further embodiments include cathode and anode free flake particulates consisting of free flake particles comprising anode or cathode electroactive phases in the form of grains. Some embodiments include anode or cathode electroactive phases with average grain sizes less than 300 nm, less than 150 nm or even less than 100 nm. In some embodiments the crystallographic directions of the grains are preferentially oriented with respect to the orientation of the flakes.

Some embodiments include cathode and anode free particulates in which the free particles comprise an anode or cathode electroactive phase and a conductive additive. Exemplary conductive additives include carbon and titanium nitride. Carbon conductive additives may be graphitic or non-graphitic. Exemplary carbon conductive additives include graphite, carbon black, and carbon nanotubes. Conductive additives may be utilized directly as a feedstock particulate component or as a conductive precursor feedstock particulate component. In the latter case the product particles of the MM process may include a conductive precursor, which may be further processed (for example, by heating) to form the conductive additive. As an example, conductive precursors for carbon conductive additives may include substances that decompose upon heating in an inert atmosphere to produce carbon, such as pitch, glucose, polyacrylonitrile, and phenolic resin. Conductive additives incorporated into the free particles can aid in electrical and ionic conductivity during Li-ion battery operation. However, excessive amounts of carbon additive can reduce the free particulate's specific capacity. Some preferred embodiments are those in which the conductive additive content in the free particles is between 1 wt % to 10 wt %, between 1 wt % to 5 wt % or between 1 wt % to 2 wt % or between 0.5 wt % to 1 wt %.

Some embodiments advantageously include free particulates having low internal porosity. The internal porosity of a free particulate can be determined from the difference of the free particulate theoretical true density and the free particulate density as measured by helium pycnometry. Some preferred embodiments include free particulates in which the internal porosity is less than 5%, less than 2%, less than 1% or even lower.

Some embodiments advantageously enable free particulate with low surface area. Low surface areas reduce surface reactivity with electrolyte, resulting in improved capacity retention. Free flake particulates in which the volumetric surface area is less than 30 m²/ml, less than 25 m²/ml, 20 m²/ml, less than 10 m²/ml or even lower are advantageously enabled by the methods disclosed herein.

In some embodiments, free particulates are essentially composed of free flake particles that have a flake diameter of 5 μm-50 μm, a thickness of 0.1 μm-10 μm, and an aspect ratio of at least 5. Favorable embodiments include free flake particulate essentially composed of free flake particles that have a flake diameter of 5 μm-25 μm, a thickness of 0.1 μm-5 μm, and an aspect ratio of at least 5. Particularly favorable are free flake particles that have a flake diameter of 10 μm-20 μm, a thickness of 1 μm-2 μm, and an aspect ratio of at least 10. Further, such free flake particles may have a radius of curvature. In some preferred embodiments, the free flake particles have a radius of curvature that is less than 150 μm, less than 50 μm or even less. Without being bound by theory, it is believed that such particles have improved flowing properties, allowing them to be more easily handled and allowing them to more easily configure themselves into high-packing arrangements during the calendering process. However, a flake radius of curvature that is too small may result in lower packing density. In some preferred embodiments, the flake radius of curvature is greater than half of the flake diameter. In particular, some embodiments include free flake particulate having an average flake diameter of 10 μm-20 μm and a flake radius of curvature of about 25 μm.

### Electrode for Electrochemical Cell

Another aspect of the present disclosure are unique electrodes for use in electrochemical cells such as Li-ion batteries. Such electrodes can comprise the aforementioned free particulate with practical loadings yet unexpectedly low porosities while delivering competitive or superior electrochemical performance.

In the prior art, free particle porosities that are too low can prevent electrolyte infiltration into the cathode coating, resulting in poor battery rate capability, and porosities that are too high can result in low energy density, poor electrical conductivity, and increased reactivity with electrolyte. However, in some embodiments of the present disclosure, the highly dense coatings made with flake particles surprisingly do not follow these rules. Instead, high rate capability may be achieved with a coating with a high density and a low porosity that typically would not function well with conventional particles. In some embodiments, electrodes comprise flake particles with a porosity approaching zero that still have high loadings and exhibit improved performance in electrochemical cells.

In some embodiments, a novel electrode for an electrochemical cell can comprise a porous electroactive coating on a current collector in which the electroactive coating comprises greater than 80% by weight free particulate and a binder. For example, in some embodiments, the electroactive coating comprises greater than 80%, 85%, 90%, 95%, or more (or a range constructed from any of the aforementioned values) by weight free particulate The free particulate can comprise free particles as described herein. For example, in some embodiments, the free particulate comprises free particles wherein each free particle comprises greater than 80% by weight electroactive phase (for example, LFP) and have an average particle size in the range of 5 μm-30 μm, and an average aspect ratio of at least 1.5.

In some embodiments, the loading of the electrode coating on the current collector is 2 mAh/cm², 3 mAh/cm², 4 mAh/cm², 5 mAh/cm², 6 mAh/cm², or greater, or a range constructed from any of the aforementioned values. In some embodiments, the electrode coating has an electrode porosity that is less than 20%, for example, 20%, 19%, 18%, 17%, 16%, 15%, 14%, 13%, 12%, 11%, 10%, 9%, 8%, 7%, 6%, 5%, 4%, 3%, 2%, 1%, or a range constructed from any of the aforementioned values. In some embodiments, the electrode coating can uniquely be less than 20% porous with a loading on the current collector greater than 2 mAh/cm². In some embodiments, the electrode coating can even be less than 15% porous and/or the loading of the electrode coating on the current collector can be greater than 3 mAh/cm².

The aforementioned novel free particulate and electrodes can be particularly useful in lithium ion rechargeable batteries. For instance, a lithium ion battery can desirably comprise an anode, a cathode, and an electrolyte in which the cathode may comprise one of the aforementioned electroactive free particulate cathode materials and in which the anode may comprise one of the aforementioned electroactive free particulate anode materials. Or for instance, a lithium ion rechargeable battery can desirably comprise the aforementioned low porosity electrode.

In some embodiments, the cathode material may have a spinel structure. In some embodiments, the cathode material may have an olivine structure.

In some embodiments, the cathode materials may have the α-NaFeO₂ structure or similar structures with orthorhombic or monoclinic distortions.

In embodiments of such electrodes, the free particles therein can consist of grains with an average size less than 300 nm. Further still, the free particles can comprise additional components such as a solid conductive diluent (for example, graphite, carbon black, carbon nanotubes), a binder or other adhesion promoter, and so on.

### Definitions

Unless the context requires otherwise, throughout this specification and claims, the words “comprise”, “comprising” and the like are to be construed in an open, inclusive sense. The words “a”, “an”, and the like are to be considered as meaning at least one and are not limited to just one.

With regards to a given item, the transitional phrase “consisting essentially of” is to be construed as limiting to the specified materials or steps “and those that do not materially affect the basic and novel characteristic(s)” of the given item. For example, the phrase “the NMC consist essentially of crystalline grains” is to be construed so as to allow the presence of a small amount of non-crystalline grains to the extent their presence does not materially affect the novel characteristics of free particles.

Language of degree used herein, such as the terms “approximately,” “about,” “generally,” and “substantially” as used herein represent a value, amount, or characteristic close to the stated value, amount, or characteristic that still performs a desired function or achieves a desired result.

In a quantitative context, the term “about” should be construed as being in the range up to plus 5% and down to minus 5% of the stated value.

In addition, the following definitions are to be applied throughout the specification:

Herein, the term “particulate” refers to a plurality of particles or aggregated particles.

The term “free particles” refers to particles that are not attached to nor supported on template particles. In a like manner, “free particulate” then refers to a particulate consisting essentially of free particles.

The term “template particles” refers to nominally spherical media used during the mechanofusion step of the MM method in the preparation of free particles.

Herein, the term “electrochemically active phase” or “electroactive phase” or “active phase” should be interpreted as would be understood by a person having skill in the art but generally refers to a phase of matter that undergoes electrochemical redox reactions during cell charge or discharge that are directly utilized for storing and delivering electrical energy. In the case of a lithium-ion battery, cathode electroactive phases are those that can reversibly electrochemically react with Li⁺ ions during normal cell operation at potentials greater than 2.5 V versus Li/Li⁺, such as LiCoO₂, NMC, LFP, NCA, Co-free NMC, and LiMn₂O₄. In the case of a lithium-ion battery, anode electroactive phases are those that can reversibly electrochemically react with Li⁺ ions during normal cell operation at potentials lower than 2 V, versus Li/Lit, such as graphite, hard carbon, and Li₄T₁₅O₁₂.

The term “inactive phase” should be interpreted as would be understood by a person having skill in the art but generally refers to a phase of matter that does not undergo redox reactions during cell charge or discharge.

The term “electroactive material”, “active material”, “electroactive particulate” or “active particulate” refers to a particulate whose constituent particles comprise at least 80% by weight active phase.

The term “electroactive free particulate” or “active free particulate” refers to a free particulate whose constituent free particles comprise at least 80% by weight active phase.

The term “electroactive cathode material” or “cathode material” refers to an electroactive material that comprises at least 80% by weight cathode electroactive phases.

The term “electroactive anode material” or “anode material” refers to an electroactive material that comprises at least 80% by weight anode electroactive phases.

The term “grain” refers to a domain within a material that is a single crystal. Grains are also referred to as “crystallites” by those skilled in the art, the terms being used interchangeably herein. The presence of grains within a material can be determined from its x-ray diffraction pattern obtained using a conventional laboratory x-ray diffractometer using Cu-Kα radiation in the range of 10° to 80° two-theta. The presence of grains in a material is indicated by the presence of x-ray diffraction peaks in the material's x-ray diffraction pattern that are characteristic of a crystalline material (for example, peaks with a full width half maximum of less than about 3° two-theta). A material having an x-ray diffraction pattern that consists essentially of x-ray diffraction peaks that are characteristic of a crystalline material is indicative of a material that is essentially composed of grains. A material having an x-ray diffraction pattern in which the peaks corresponding to a particular phase or component of the material consists essentially of x-ray diffraction peaks that are characteristic of a crystalline material is indicative of a phase or component within the material that is essentially composed of grains.

The term “intra-grain layering” refers to a layered arrangement that occurs inside of a grain due to the crystallographic arrangements of the atoms within the grain.

The term “inter-grain layered” or “arranged in inter-grain layers” refers to an arrangement of grains within a free particle such that the grains are statistically arranged in a lamellar pattern parallel to the major plane of the free particle. An inter-grain layered arrangement is indicated by the preferential orientation of grains within the particles with a preferential orientation parameter that is greater than 1.02 or less than 0.98.

The “major plane” of a free particle corresponds to the plane in the free particle that is parallel to its largest area cross section.

The term “particle diameter” or “particle size” refers to the diameter of a sphere having the same volume of the particle in question. The terms “average particle diameter” or “average particle size” refers to the average of the particle diameters of the particles comprising a particulate.

The term “particle width” or “flake diameter” but also represents the diameter of a circle having the same area as the largest area cross section of the particle in question.

The term “average flake diameter” or “average particle width” refers to the average of the flake diameters or particle widths of the particles comprising a particulate.

The term “particle thickness” or “flake thickness” but also refers to the length of the axis of a cylinder having the same volume of the particle in question and having a diameter equal to the particle width of the particle in question.

The “aspect ratio” of a particle is the particle width divided by the particle thickness.

The “average aspect ratio” of a particulate refers to the average of the aspect ratios of all particles comprising a particulate that have a particle width that is greater than 1 μm.

The term “flake particle” or “flake” refers to a thin particle (typically broken from a larger piece) that is defined as being of substantially uniform thickness having a surface (the face) substantially perpendicular to the thickness and having an aspect ratio of at least 5. The face of a flake may also have curvature, with the radius of curvature parallel to the thickness direction. Here, the term “substantially” indicates that a set of values can be considered to be substantially equivalent to a nominal value if the standard deviation in their distribution is less than 10% of the mean value.

The term “potato shape” or “potato morphology” refers to a particle having an aspect ratio between 1.5 and 5.

The term “internal porosity” refers to the void space (or pore volume) that is totally enclosed within a material. When applied to a particulate the term “internal porosity” refers to the total void space (or pore volume) that is totally enclosed within the individual particles constituting the particulate. The internal porosity of a material is often expressed as a percent quantity that refers to the percent of the total volume that a material occupies that is associated with the material's porosity and may be expressed as:

percent internal porosity=(pore volume)÷(total material volume)×100%

Where the total material volume includes the pore volume. For a particulate sample, the total material volume does not include void spaces between particles.

The term “electrode porosity” refers to the void space within an electrode coating corresponding to the exterior volume of the electrode coating as determined from measuring its external dimensions (for example, with a micrometer) minus the volume of the electrode calculated from the true density of its components. The electrode porosity is often expressed as a percent as follows:

percent electrode porosity=((electrode coating volume as measured from its external dimensions)−(electrode coating volume as determined from the true density of its components))/(electrode coating volume as measured from its external dimensions)

The term “preferred orientation” refers to an arrangement of crystallites having a non-random alignment of their crystal axes. The preferred orientation of a particulate sample may be quantified as the “preferred orientation parameter” as determined using the Dollase and March model applied to the powder x-ray diffraction pattern of the sample as measured on a flat plate sample holder as described in Dollase, W. A. (1986). J. Appl. Cryst., 19, 267-272 and in A. C. Larson and R. B. Von Dreele, “General Structure Analysis System (GSAS)”, Los Alamos National Laboratory Report LAUR 86-748 (2004). The preferred orientation parameter is equal to 1 for samples having no preferred orientation. The preferred orientation parameter is less than one for plate-like crystals that are arranged such that the plate faces are preferentially aligned parallel to the flat plate sample holder. The preferred orientation parameter is greater than one for needle-like crystals that are preferably arranged with the needle long axis parallel to the flat plate sample holder. The “preferred orientation direction” is denoted by the Miller indices [hkl] of the preferred orientation crystallographic plane. For plate-like crystals that are arranged such that the plate faces are preferentially aligned parallel to a flat plate sample holder, the preferred orientation direction is the Miller indices [hkl] of the crystallographic plane parallel to the crystallographic plane corresponding to the faces of the plate-like crystals. For needle-like crystals that are arranged such that the needle long axes are preferentially aligned parallel to a flat plate sample holder, the preferred orientation direction is the Miller indices [hkl] of the crystallographic plane perpendicular to the long axis of the needle-like crystals.

“Impact milling” is the process of particle pulverization due to particle impact with other particles, with milling apparatus or with milling media. Impact milling may be conducted with the particles in a gas or vacuum (dry impact milling), where gases such as air or inert gases, including nitrogen may be used. Impact milling may also be performed with the particles in a liquid (wet impact milling). However, dry impact milling methods are generally preferred over wet impact milling methods, since dry impact milling methods avoid additional steps, such as filtering or drying, associated with utilizing wet impact milling methods. Impact milling processes that use no milling media are preferred, since they reduce the possibility of damaging the flakes after they have separated from the template particles. Some impact milling methods include jet milling, pin milling, and centrifugal impact milling. At small laboratory scales, centrifugal impact milling may be conducted using a kitchen blender or coffee grinder. Impact milling methods that include a separation process that removes and collects free flakes as they are produced are particularly desirable. In some instances, the separation step may be performed after the impact milling process is completed. Suitable separation processes include cyclone air classification and sieving. In this way, free particulate may be collected that essentially consists only of free particles, thereby forming product free particulate.

The term “primary particle” refers to a particle composed of one domain or multiple domains that are strongly bonded together. Primary particles cannot be easily broken into smaller constituents by dry grinding.

The term “secondary particle” refers to an agglomerate of weakly bound primary particles.

The term “anode” refers to the electrode at which oxidation occurs when a metal-ion cell is discharged. In a lithium ion cell, the anode is the electrode that is delithiated during discharge and lithiated during charge.

The term “cathode” refers to the electrode at which reduction occurs when a metal-ion cell is discharged. In a lithium ion cell, the cathode is the electrode that is lithiated during discharge and delithiated during charge.

The term “metal-ion cell” or “metal-ion battery” refers to alkali metal ion cells, including lithium ion cells and sodium ion cells.

The term “half-cell” refers to a cell that has a working electrode and a metal counter/reference electrode. A lithium half-cell has a working electrode and a lithium metal counter/reference electrode.

The terms “mechanofusion” and/or “mechanofusing” (also referred to as “MF”) as used herein refers to mechanically fusing small particles onto larger particles to form a coating, for example template particles and feedstock particles. For example, mechanofusion may fuse materials by the use of high shear force and/or high pressure fields. For example, mechanofusion may be a dry process without the use of a solvent. Mechanofusion may be used to coat template particles with feedstock particles.

The following examples are illustrative of aspects of some embodiments but should not be construed as limiting the disclosure in any way. Those skilled in the art will readily appreciate that other variants are possible for the methods and materials produced herein.

### EXAMPLES

Exemplary free particulate of either LiFePO₄ or NMC was prepared using dry mechanofusion and impact milling in accordance with some embodiments herein. Other particulate was also prepared for comparison purposes. Various characteristics of these particulates were determined and presented below. In addition, electrodes and electrochemical cells were prepared using these particulates. The cell performance results obtained from the electrochemical cells are also presented below.

### Preparatory and Analytical Methods Employed

### Mechanofusion Processing

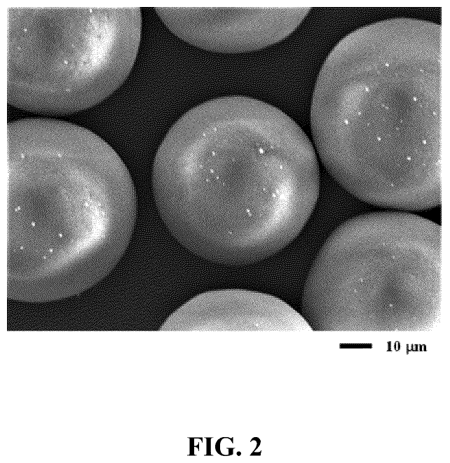

Mechanofusion processing was conducted using a modified AM-15F Mechanofusion System (Hosokawa Micron Corporation, Osaka, Japan). This machine was modified by replacing the standard stainless-steel chamber, scraper, and press-head with identical hardened steel parts to reduce wear. Unless otherwise specified, mechanofusion processing was conducted with a 1.4 mm press head gap and a 0.5 mm scraper gap. The chamber had a 15 cm inner diameter. Unless otherwise indicated, the gas atmosphere used during mechanofusion processing was air. Unless otherwise indicated, mechanofusion processing was applied to a mixture of feedstock particulate and template particles, where the template particles used were ZrO₂ spheres (50 μm, Glen Mills). An SEM image of these template particles is shown in FIG. 2.

### Impact Milling

Unless otherwise specified, impact milling was conducted with a coffee grinder (CBG110S/BLACK+DECKER) as follows. 80 g of material was placed into the coffee grinder and pulse-ground (grinding time of 1 second for each pulse) for 15-20 pulses.

### BET Surface Area

The specific surface areas of the sample materials were determined by the single-point Brunauer-Emmett-Teller (BET) method using the Nova 4200e surface area and pore size analyzer.

### X-Ray Diffraction

X-ray different (XRD) pattern analysis was conducted using a Rigaku Ultima IV diffractometer equipped with a Cu Kα X-ray source, a diffracted beam monochromator and a scintillation detector. Each XRD pattern was collected from 10° to 80° 2-theta with 0.05° increments for 3 seconds per step. Lattice constants, atom positions, preferred orientation direction, preferred orientation parameters, and x-ray peak positions and full width half maximum (FWHM) values were determined by Rietveld refinement utilizing LHPM refinement software (A Computer Program for Rietveld Analysis of X-Ray and Neutron Powder Diffraction Patterns Australian Nuclear Science and Technology Organization, Lucas Heights Research Laboratories, February 2000). Rietveld refinements of LiFePO₄ phases were conducted using space group Pnma, with Li occupying 4a sites and P and Fe each occupying their own unique 4c site. Oxygen atoms were located on three unique sites, labelled as O1, O2, and O3; where O1 and O2 are 4c sites and O3 is an 8d site. Lattice constants and any atomic fractional coordinates allowed to vary within their Wyckoff position were made variable during the refinements. Average crystallite sizes and average lattice strains of different phases were determined from x-ray peak positions and FWHM values obtained from Rietveld refinements for those peaks whose FWHM were greater than the instrumental broadening error (0.1°) by using the Williamson-Hall method, as described in Emil Zolotoyabko, “Basic Concepts of X-Ray Diffraction”, February 2014, John Wiley & Sons.

Grain sizes were determined by applying the Scherrer equation to the largest x-ray diffraction peak of the particulate.

### SEM and Cross-Sectional SEM

Material morphology was analyzed using a scanning electron microscope (SEM) (JEOL JSM-IT200 InTouchScope Scanning Electron Microscope, JEOL Ltd., Tokyo, Japan). Broad ion beam (BIB) cross-sectioning of SEM samples was performed with an argon ion beam in a cross-section polisher (JEOL IB-19530 CP Cross-Section Polisher, JEOL Ltd., Tokyo, Japan). Focused ion beam (FIB) cross-sectioning of SEM samples was performed with a Hitachi FB-2000A FIB System with a liquid gallium source. Particle sizes, particle widths, and average particle thicknesses were determined from the dimensions of at least 50 particles chosen at random as observed by SEM. Average aspect ratios were determined from the dimensions of at least 50 particles with particle widths greater than 1 μm chosen at random as observed by SEM.

### Electrode Coating Characteristics

Electrode coating thicknesses were determined by measuring the total electrode thickness (with a Mitutoyo 293-340 precision micrometer) and then subtracting the electrode current collector thickness (also measured with a Mitutoyo 293-340 precision micrometer.). Electrode loadings were measured by weighing a 1.3 cm² disk cut from the electrode using a precision die. The coating weight of this electrode disk was then determined by subtracting the weight of current collector of the same area from the electrode weight. The coating weight per area and the amount of electroactive material per unit area (the loading), and the coating density could then be determined. The electrode porosity was determined from the electrode coating thickness (t) and the theoretical zero porosity electrode coating thickness (t°, calculated for the same electrode loading using true densities) as follows:

$$\% electrode porosity = ( t - t ° ) / t \times 100 \%$$

### Electrode Preparation

Sample electrodes for laboratory testing were prepared from slurries consisting of the particulate material, carbon black (Super C65, Imerys Graphite and Carbon) and polyvinylidene fluoride binder (PVDF) (in the weight ratio indicated in Table 1) in 1-methyl-2-pyrrolidone (NMP, Sigma Aldrich, 99.5% anhydrous). Slurries were mixed for a total time of 1800 seconds (30 minutes) using a high-shear mixer and then spread onto aluminum foil with a coating bar with a 0.016 inch gap. Electrodes were then dried in air for 1-1.5 hours at 120° C. Electrodes were compressed with a calender (DPM Solutions, Hebbville NS) equipped with two 6″ diameter heated rolls and an adjustable nip. Calendering was performed at sequentially smaller nip heights until the minimum nip height before electrode delamination occurs was reached (the nip height at which electrode coating delamination occurs being determined by successively calendering a section of the electrode until electrode coating delamination occurred). Dried and calendered electrodes were cut into 1.3 cm disks and heated under vacuum overnight at 120° C. prior to cell preparation. The electrode loadings (i.e. mg electroactive particulate/cm²) are listed in Table 1.

TABLE 1
Electrode characteristics

| | | | | Electrode | | |
|---|---|---|---|---|---|---|
| | Electrode Formulation (weight %) | | | Loading | Coating | Electrode |
| | Electroactive | Carbon | | (mg electroactive | Density | Porosity |
| Example | Particulate | Black | PVDF | particulate/cm²) | (g/cm³) | (%) |
| CE1 | 90 | 5 | 5 | 12.91 | 2.168 | 31 |
| IE1 | 90 | 5 | 5 | 14.79 | 2.719 | 14 |
| IE2 | 90 | 5 | 5 | 13.55 | 2.235 | 30 |
| IE3 | 90 | 5 | 5 | 14.95 | 3.531 | 15 |

### Cell Preparation and Testing

To evaluate the various materials as electrode materials in Li-ion cells, laboratory test lithium half-cells were constructed and tested. Sample electrodes were assembled in 2325-type coin cells. The cell contents consisted of (in order of construction) a copper spacer, a lithium foil (99.9%. Sigma Aldrich) counter/reference electrode, one polypropylene/polyethylene/polypropylene trilayer separator (Celgard 2300, Celgard, LLC, North Carolina, USA), a polypropylene blown microfiber (BMF) membrane (3M Company), the sample electrode, and an aluminum spacer. (Note: as is well known to those skilled in the art, results from these test lithium half-cells allow for reliable prediction of electrode materials performance in lithium ion batteries.) During cell assembly the sample electrode, trilayer separator, BMF membrane, and lithium foil were thoroughly wet with an electrolyte solution of 1M LiPF₆ (BASF) in a solution of ethylene carbonate, diethyl carbonate and fluoroethylene carbonate in a volume ratio of 3:6:1 (all from BASF). Coin cell assembly was conducted in an Ar-filled glovebox. Cells made with LFP sample electrodes were cycled galvanostatically at 30.0±0.1° C. between 2.5 V and 3.65 V according to three testing protocols, denoted as P1, P2 and P3. For all testing protocols, C-rate was defined as the current required to fully charge or discharge the active material in 1-hour based on a theoretical active material capacity. For LFP, C-rate was based on a theoretical LFP capacity of 170 mAh/g. For NMC622, C-rate was based on a theoretical NMC622 capacity of 200 mAh/g. In Protocol 1 (P1), the first cycle was conducted at a rate of C/20, and subsequent cycles were performed at a constant rate of C/10. In Protocol 2 (P2), first cycle was conducted at a rate of C/20 and subsequent cycles were conducted cycling rates that increased every five cycles from 0.1 C, 0.2 C, 0.5 C, 1 C, 2 C, 5 C, to 10 C where both charge and discharge rates were kept equal to each other. Protocol 3 (P3) was the same as P2, excepting that after the initial C/20 cycle, the charge cycle remained at a constant 0.1 C rate with only the discharge rate increasing every five cycles from 0.1 C, 0.2 C, 0.5 C, 1 C, 2 C, 5 C, to 10 C. All cells were cycled using a Maccor Series 4000 Automated Test System.

### Comparative Example (CE1)

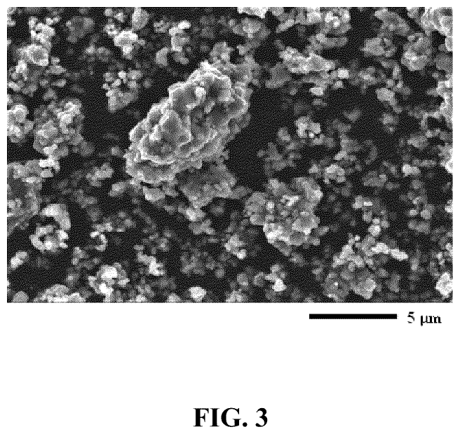

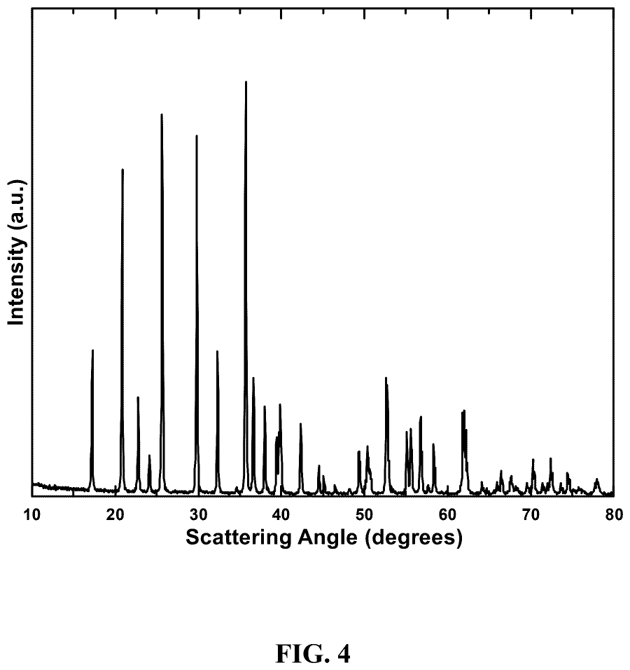

LiFePO₄ (denoted as LFP) particulate (P198-S13, BTR New Materials Group Co Ltd, China) was used as received (denoted as “CE1 particulate”). FIG. 3 shows an SEM image of CE1 particulate, which consists of primary particles that are mostly 0.1 μm-1 μm in size. Some of the primary particles are aggregated into secondary particles with a diameter of about 5 μm-7 μm. The BET surface area of CE1 particulate was measured to be 11.69 m²/g and the density of CE1 particulate was measured to be 3.507 g/ml. This corresponds to a volumetric surface area (VSA) for CE1 particulate of 41.0 m²/ml. FIG. 4 shows the X-ray diffraction (XRD) diffraction pattern of CE1 particulate. It is characteristic of highly crystalline LiFePO₄ having an ordered olivine structure indexed to the orthorhombic Pnma space group. Unit cell parameters, atom positions, and preferred orientation values obtained from Rietveld refinement of CE1 particulate are listed in Table 2. No preferred orientation could be detected in this sample for any crystallographic direction (i.e. the preferred orientation parameter was equal to 1). From the x-ray diffraction pattern, the average LiFePO₄ grain size and strain were determined to be 206 nm and 0.04%, respectively.

TABLE 2
Rietveld refinement results for the materials prepared according to CE1, IE1, and
IE2 where a, b, and c are the unit cell lattice constants, Pₖ refers to the preferred
orientation parameter, [hkl] represents the preferred orientation direction,
hkl are the Miller indices, and x, y, and z are atomic fractional coordinates.

| Refined | | | |
|---|---|---|---|
| Parameters | CE1 | IE1 | IE2 |
| a (Å) | 10.324613 | 10.321907 | 10.31950 |
| b (Å) | 6.00505 | 6.006413 | 6.005590 |
| c (Å) | 4.692141 | 4.693701 | 4.693974 |
| preferred | 1/[no preferred | 0.92887/[101] | 0.94438/[101] |
| orientation | orientation direction] | | |
| (Pₖ/[hkl]) | | | |
| crystallographic | 0.04 | 0.05 | 0.04 |
| strain (%) | | | |
| Scherrer grain | 206 | 160 | 145 |
| size (nm) | | | |
| Fe (x, y, z) | 0.2825, 0.25, 0.9736 | 0.2825, 0.25, 0.9734 | 0.2828, 0.25, 0.9716 |
| P (x, y, z) | 0.0946, 0.25, 0.4173 | 0.0938, 0.25, 0.4165 | 0.0936, 0.25, 0.4169 |
| O1 (x, y, z) | 0.0975, 0.25, 0.7474 | 0.0978, 0.25, 0.7525 | 0.0982, 0.25, 0.7533 |
| O2 (x, y, z) | 0.4562, 0.25, 0.2108 | 0.4535, 0.25, 0.2026 | 0.4533, 0.25, 0.2109 |
| O3 (x, y, z) | 0.1669, 0.0417, 0.2814 | 0.1656, 0.0439, 0.2826 | 0.1640, 0.0441, 0.2816 |
| Bragg R | 3.40 | 4.06 | 5.66 |

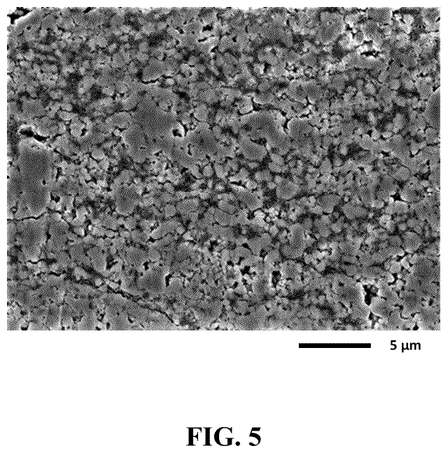

Electrodes in which CE1 particulate served as the electroactive particulate were formulated according to Table 1. An electrode coating density of 2.164 g/cm³, corresponding to an electrode porosity of 31% could be achieved with this coating before electrode coating delamination occurred. FIG. 5 shows an SEM image of a cross-section of the electrode coating of CE1. It comprises randomly packed LFP particles with the same size distribution as the pristine CE1 particulate with carbon black and porosity residing in the gaps between particles.

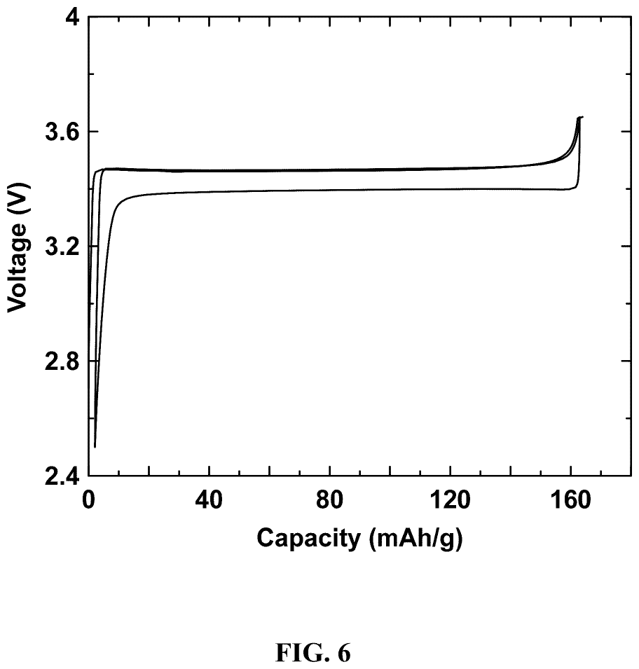

Lithium half-cells were prepared using the electrode coating of CE1 as the working electrode. FIG. 6 shows the voltage curve of one of these cells cycling according to protocol P1. The voltage curve is characteristic of conventional LFP based cathodes. The cell had an initial coulombic efficiency (ICE) of 98.7%. A 161.26 mAh/g reversible capacity was obtained with an average discharge voltage of 3.36 V. Combined with the electrode coating density, listed in Table 1, this corresponds to a coating energy density of 1174 Wh/L.

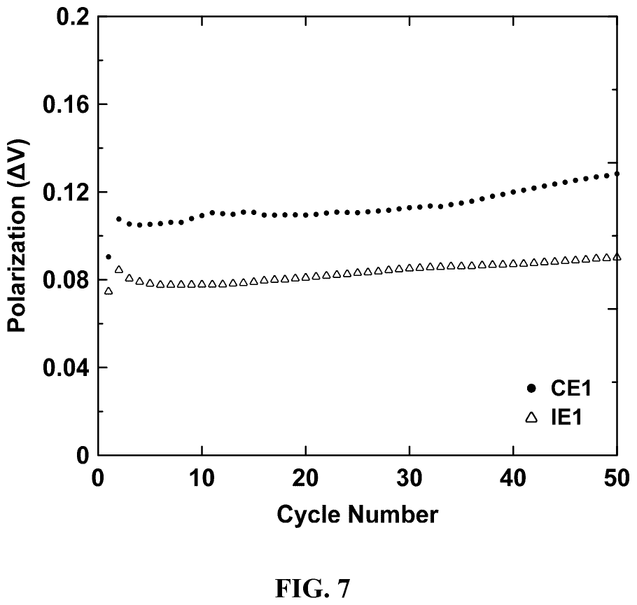

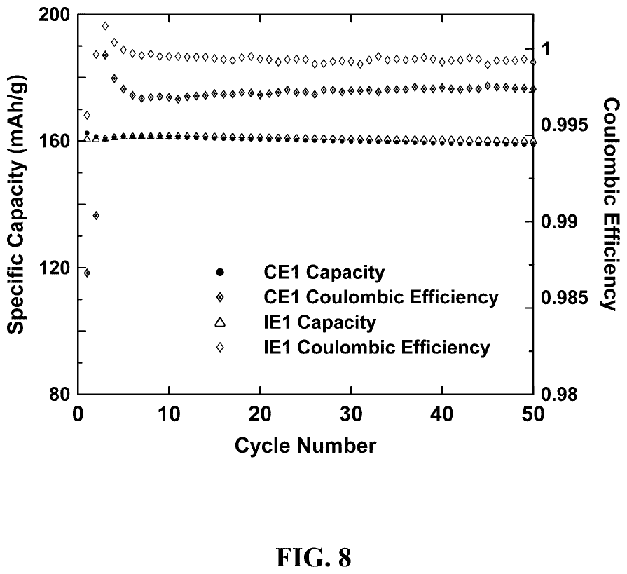

FIG. 7 shows the polarization of the same cell shown in FIG. 6 plotted as a function of cycle number. An average polarization of 0.12 V was achieved over 50 cycles. FIG. 8 shows the capacity and coulombic efficiency (CE) of the same cell shown in FIG. 6 plotted as a function of cycle number. The cell had a capacity fade of 0.97% between cycles 6 and 50 and an average CE of 0.997.

### Example (IE1)

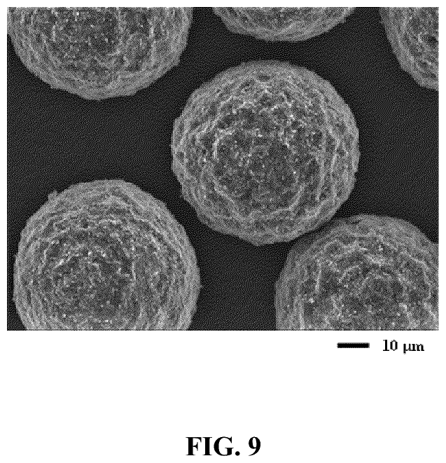

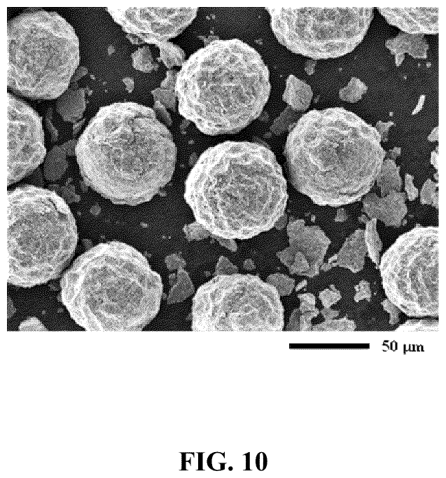

An LFP/carbon composite free flake particulate was synthesized as follows. 10.85 g of CE1 particulate, 0.22 grams of natural graphite (Grade 230U, Asbury Graphite Mills, Kittanning PA), and 225 g of ZrO₂ spheres (50 μm, Glen Mills) which served as template particles were mechanofusion processed at 1000 rpm for 20 minutes. Following the 20 minutes of mechanofusion processing, a uniform coating of unheated LFP/carbon composite was achieved on the ZrO₂ spheres, as shown in FIG. 9. The coated ZrO₂ spheres were then impact milled as described above. FIG. 10 shows an SEM image of the coated ZrO₂ spheres following impact milling. Much of the unheated LFP/carbon composite coating on the ZrO₂ spheres flaked off during the impact milling process, resulting in the formation of a mixture of partially coated spherical ZrO₂ template particles and unheated LFP/carbon composite free flake particulate.

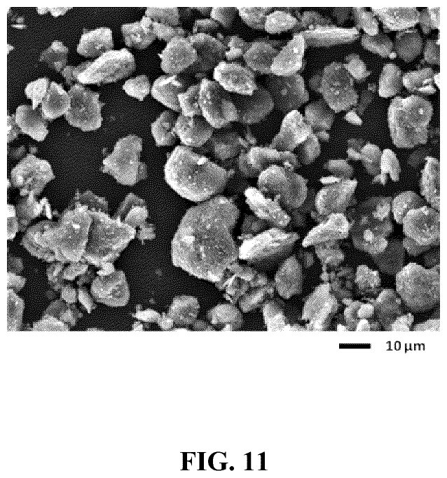

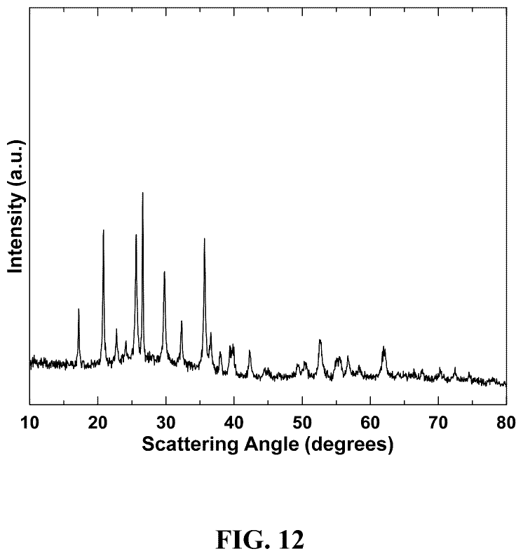

The unheated LFP/carbon composite free flake particulate was separated from the partially coated ZrO₂ spheres using a 38 μm sieve. A SEM image of the unheated LFP/carbon composite free flake particulate is shown in FIG. 11. More than 95% of the free flake particulate is in the form of free particles that have a characteristic flake morphology with flake widths in the range of 10-20 μm and a flake thickness in the range of 2-5 μm. FIG. 12 shows an XRD pattern of the unheated LFP/carbon composite free flake particulate. It contains peaks characteristic of LFP, but the peaks are broader than the crystalline LFP particulate as originally received, indicating grain size reduction and defect formation occurred in the structure. In addition to the peaks from LFP, the XRD pattern of the unheated LFP/carbon composite free flake particulate includes a peak from the graphite (002) reflection at about 26.4°, reflecting the presence of graphitic carbon incorporated in the free flake particles.

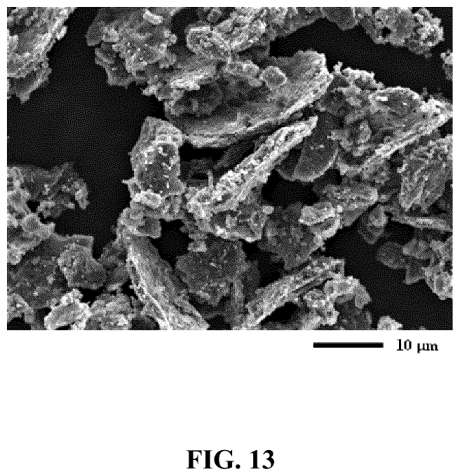

The unheated LFP/carbon composite free flake particulate was heated in a flowing 95% Ar and 5% H₂ gas mixture at a temperature of 650° C. for 10 hours to obtain the final LFP/carbon composite free flake particulate. A SEM image of the resulting IE1 free particulate is shown in FIG. 13. Its constituent particles retain the characteristic flake morphology of the unheated LFP/carbon composite free flake particulate, with flake diameters in the range of 10-20 μm and flake thicknesses in the range of 1-2 μm, corresponding to an average aspect ratio of about 10. The IE1 free flake particles also exhibit a radius of curvature of about 25 μm, imparted from the 50 μm template particles. The BET surface area of the IE1 free flake particulate was measured to be 5.23 m²/g and the density of IE1 free flake particulate was measured to be 3.468 g/ml. This corresponds to a VSA for IE1 free flake particulate of 18.1 m²/ml.

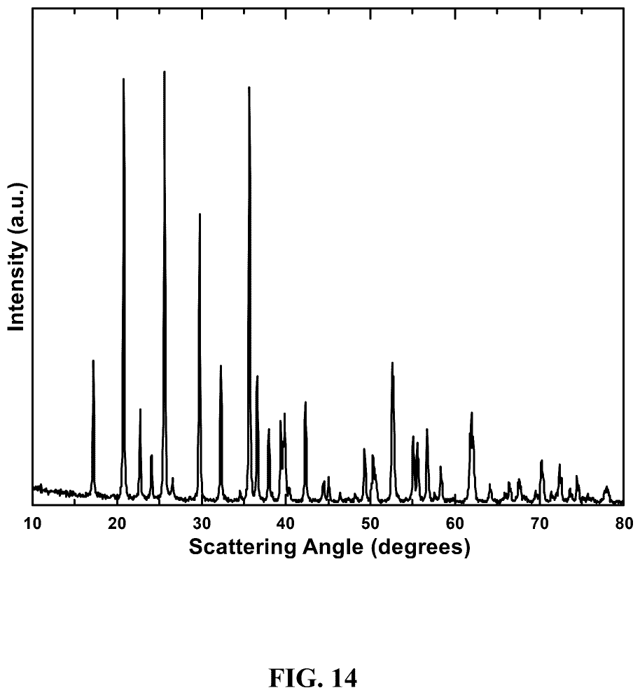

By comparing the measured density to the theoretical true density of IE1, it was determined that the internal porosity of IE1 is about 1.1%. FIG. 14 shows an XRD pattern of the IE1 free flake particulate. The XRD peaks became narrower, compared to the sample before heating, indicating that the heating step resulted in grain growth and the elimination of crystal defects. In addition to the peaks from LFP, the XRD pattern of IE1 free flake particulate includes a peak from the graphite (002) reflection at about 26.4°, reflecting the presence of graphitic carbon incorporated in the free flake particles.

Unit cell parameters, atom positions, and preferred orientation values obtained from Rietveld refinement of IE1 free flake particulate are listed in Table 2. The XRD pattern is characteristic of highly crystalline LiFePO₄ having an ordered olivine structure indexed to the orthorhombic Pnma space group and nearly the same lattice constants and atom positions as the material made according to CE1. From the x-ray diffraction pattern, the average LiFePO₄ grain size and strain were determined to be 160 nm and 0.05%, respectively.

The MM process followed by heating has resulted in a reduction of grain size compared to the CE1 sample, which is believed to be beneficial for improving lithium diffusion in LFP, thereby resulting in increased rate performance. At the same time, the lattice strain has not appreciably changed as a result of the MM process, but has remained very low, which suggests a pristine crystal structure has been achieved. Compared to the CE1 sample, the relative XRD peak intensity ratios of IE1 are significantly different. By Rietveld refinement, it was found that this was due to a preferred orientation of the LFP grains with a preferred orientation direction of [101] and with a preferred orientation parameter of 0.93. This indicates that the LFP grains that make up the IE1 free flake particles are in the form of plate-like crystals that are arranged in inter-grain layers within the IE1 free flake particles such that the faces of the LFP plate-like crystals are preferentially aligned with the major planes of the free flake particles.

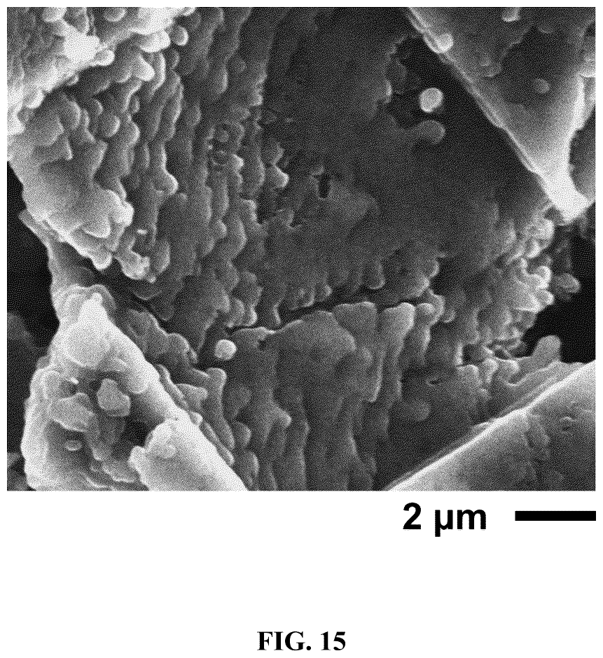

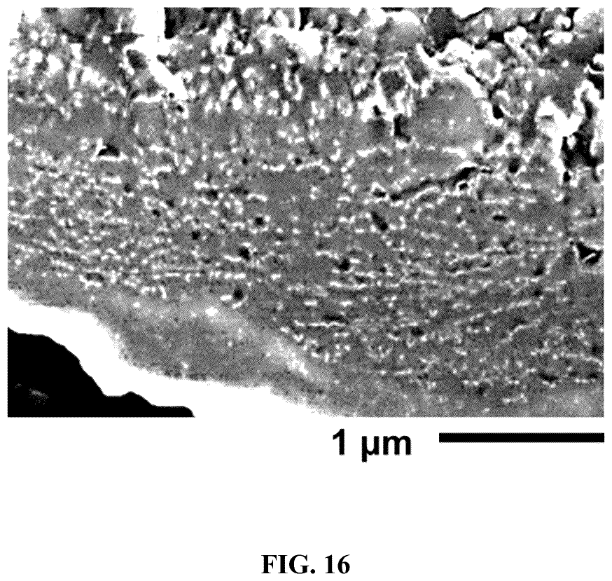

FIG. 15 shows an SEM image of a single IE1 free flake particle whose surface has been etched utilizing a focused gallium-ion beam (FIB). In this figure, the free flake particle is oriented such that its basal plane is parallel with the plane of the page. Etching this free flake particle with a gallium ion beam from above revealed internal inter-grain layering, with the inter-grain layers being parallel to the free flake particle basal plane. FIG. 16 shows an SEM image of a single IE1 free flake particle that has been cross-sectioned by a broad argon-ion beam, where the cross section is perpendicular to the free flake particle basal plane. The image in this figure is of this cross-sectioned surface. The majority of the particle is solid, however some closed pores are visible. Many of the closed pores are extremely small (50 nm) voids and are surrounded by a light border in the secondary electron image. It is believed that these small voids are formed by the vaporization of carbon in the sample during the argon-ion milling process. Therefore, they reveal the location of carbon in the sample.

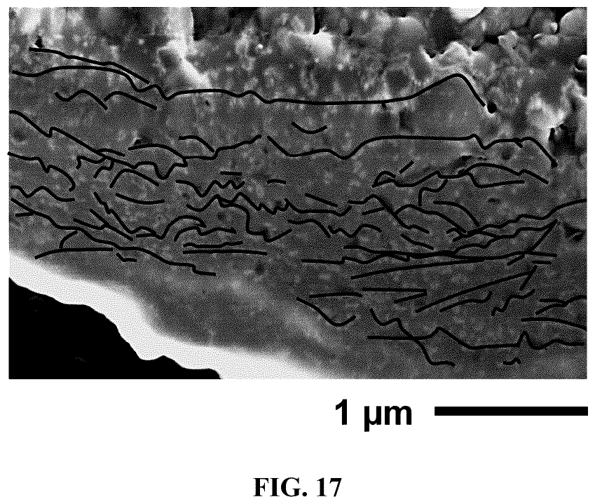

The arrangement of voids in the cross-section shown in FIG. 16 is not random, but rather is such that it suggests an inter-grain layered microstructure. Lines of voids running through the particle in this image are highlighted in FIG. 17. This microstructure can be attributed to the MM process, where the template particles are coated with LFP and graphite particles, while this coating is simultaneously subjected to high shear forces, which causes the shearing and smoothing of the graphite and LFP particles along the template particle surface. From XRD results, the LFP predominately shears along the (101) planes in this process. Such a mechanism would result in sequential graphite and LFP inter-grain layers parallel to the free flake basal plane. During subsequent heating, the LFP free particles would crystallize, causing grain growth and the partial disruption of the inter-grain layered microstructure. This grain growth is apparent on the top of the image shown in FIG. 16. This inter-grain layered microstructure explains the layered appearance of the FIB etched particle shown in FIG. 15, which would result from differences in the erosion rates of the graphite and LFP inter-grain layers during the etching process. From FIG. 16 the spacing between the inter-grain layers in the inter-grain layered microstructure varies from about 100-350 nm.

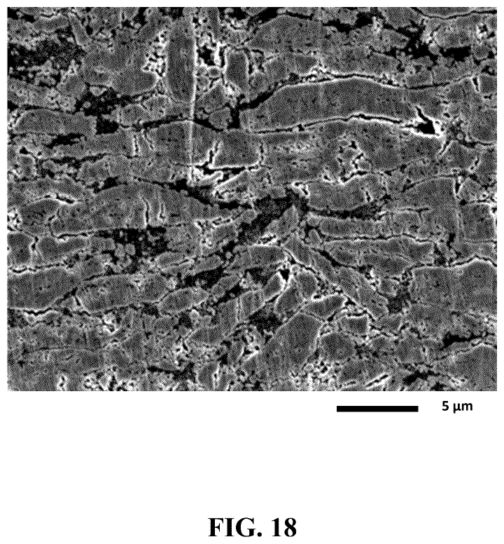

Electrodes with IE1 free flake particulate serving as the electroactive cathode material were formulated according to Table 1. An electrode coating density of 2.719 g/cm³, corresponding to an electrode porosity of 14% could be achieved with this coating before electrode coating delamination occurred. FIG. 18 shows an SEM image of a cross-section of the electrode coating of IE1. It comprises LFP/carbon composite free flake particulate with carbon black and porosity residing in the gaps between particles. The faces of the LFP/carbon composite free flake particulate are preferentially oriented parallel with the electrode current collector. Without being bound by theory, it is believed that this preferential orientation may enable the observed high electrode coating density of this electrode to be achieved.

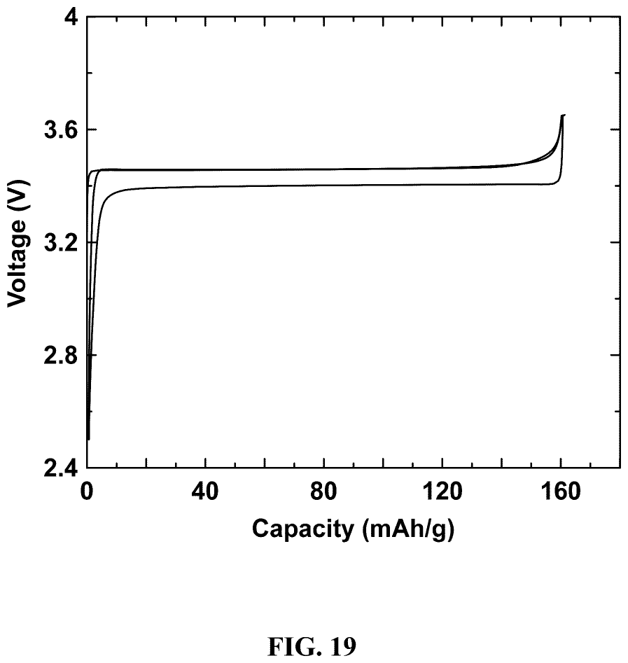

Lithium half-cells were prepared using the electrode coating of IE1 as the working electrode. FIG. 19 shows the voltage curve of one of these cells cycled according to P1. The voltage curve is characteristic of LFP based cathodes. The cell had an ICE of 99.6%. A 161.65 mAh/g reversible capacity was obtained with an average discharge voltage of 3.38 V. Combined with the electrode coating density, listed in Table 1, this corresponds to a coating energy density of 1492 Wh/L.

FIG. 7 shows the polarization of the same cell shown in FIG. 19 plotted as a function of cycle number. An average polarization of 0.08 V was achieved over 50 cycles. FIG. 8 shows the capacity and CE of the same cell shown in FIG. 19 plotted as a function of cycle number. The cell had a capacity fade of 0.97% between cycles 9 and 50 and an average CE of 0.999.

Table 1 lists some of the characteristics of the electrodes prepared according to examples CE1 and IE1. A 25% larger electrode coating density was achieved for the electrode prepared according to example IE1 than the electrode prepared according to example CE1. This is believed to be due to the improved packing properties of the IE1 free flake particulate.

Table 3 lists some electrochemical performance characteristics of CE1 particulate and IE1 free flake particulate as characterized in cells that were cycled according to P1. Due to its increased electrode density, the electrode prepared according to example IE1 has a 27% larger coating energy density than the electrode prepared according to example CE1. Furthermore, the electrode prepared according to example IE1 has a significantly higher average CE than the electrode prepared according to example CE1. This is believed to be due to the low surface area of the IE1 free flake particulate, which is 55% lower than that of the CE1 particulate. This low surface area is believed to result in less electrolyte degradation on the surfaces of the IE1 free flake particulate. Despite the low surface area of the IE1 free flake particulate, it surprisingly had significantly lower average polarization. This is believed to be due to: an improved electronic conductivity of the IE1 free flake particulate due to the presence of the carbon incorporated in these particles, an improved electronic conductivity between the IE1 free particles in the electrode coating, owing to their large surface contact area (due to the flake shape of the free particles and their preferential orientation in the electrode), and improved lithium ion diffusion (which is believed to be facilitated by diffusion in the carbon/LFP grain boundaries).

TABLE 3
Electrochemical performance characteristics
of CE1 and IE1 cells cycled according to P1.

| | Coating | | | | |
|---|---|---|---|---|---|
| | Energy | | Average | Average | Capacity |
| | Density | ICE | CE | Polarization | Fade |
| Example | (Wh/L) | (%) | (%) | (V) | (%) |
| CE1 | 1174 | 98.7 | 99.7 | 0.12 | 0.97 |
| IE1 | 1492 | 99.6 | 99.9 | 0.08 | 0.97 |

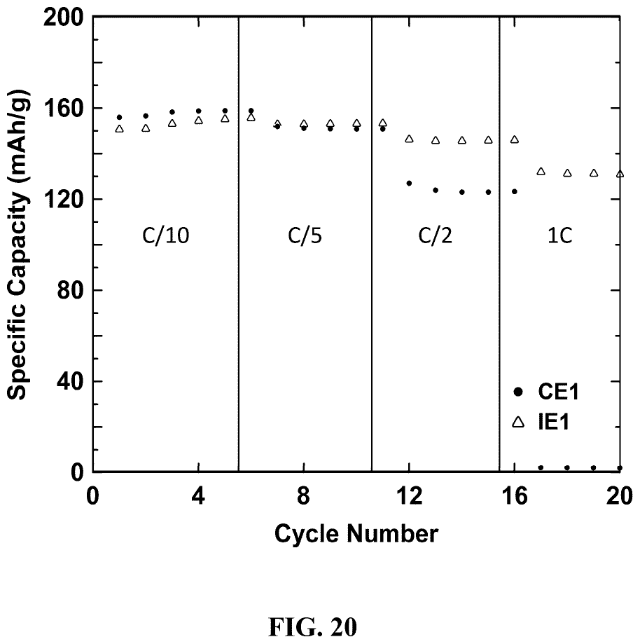

More lithium half-cells were prepared using the electrode coating of CE1 and IE1 as working electrodes. These cells were cycled according to P2. FIG. 20 illustrates the capacities of these cells at various rates. The first charge was done at rate of C/20 resulting in a capacity of 155.9 mAh/g with an ICE of 99.9% for CEL and a capacity of 150.97 mAh/g and an ICE of 96.4%. Subsequent cycles were done at various rates (C/10, C/5, C/2, 1 C) both charge and discharge with no hold, for 5 cycles respectively. Table 4 outlines the electrochemical rate performance characteristics of CE1 and IE1 particulate.

TABLE 4
Electrochemical rate performance characteristics
for cells cycled according to P2.

| | Average | Average | Average | Average |
|---|---|---|---|---|
| | C/10 | C/5 | C/2 | 1C |
| | Capacity | Capacity | Capacity | Capacity |
| Example | (mAh/g) | (mAh/g) | (mAh/g) | (mAh/g) |
| CE1 | 158.2 | 151.1 | 124.1 | 1.98 |
| IE1 | 154.2 | 153.4 | 146.2 | 131.5 |

### Example (IE2)

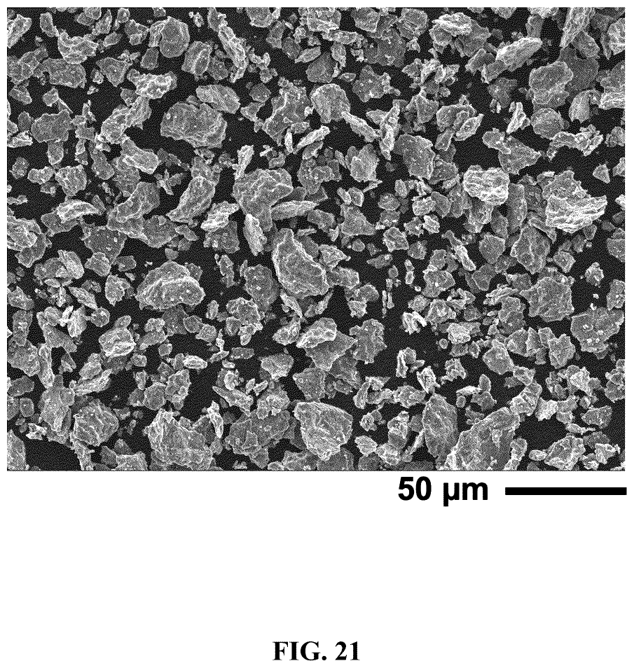

An LFP/carbon free particulate (IE2) comprising potato-shaped free particles was synthesized using the same method described in IE1, excepting the template particles were re-used from a previous synthesis of IE1. As a result of being used in a previous synthesis of IE1, these template particles had residual LFP/carbon material on their surface that had not been removed by the impact milling step. This resulted in a thicker LFP/carbon coating being formed on the template particles after mechanofusion processing. FIG. 21 shows an SEM image of the resulting IE2 free particulate. Some of the particles have a flake-like morphology. However, most of the particles are potato-shaped. The aspect ratio of the particles ranged from about 1 to 5, with an overall average aspect ratio of 2.6. The particle diameters ranged from about 0.5 to 25 μm, and the sample had an overall average particle size of about 10 μm. The density of IE2 particulate was measured to be 3.48 g/ml. The BET surface area of the IE2 free particulate was measured to be 3.620 m²/g, corresponding to a VSA of 12.6 m²/ml.

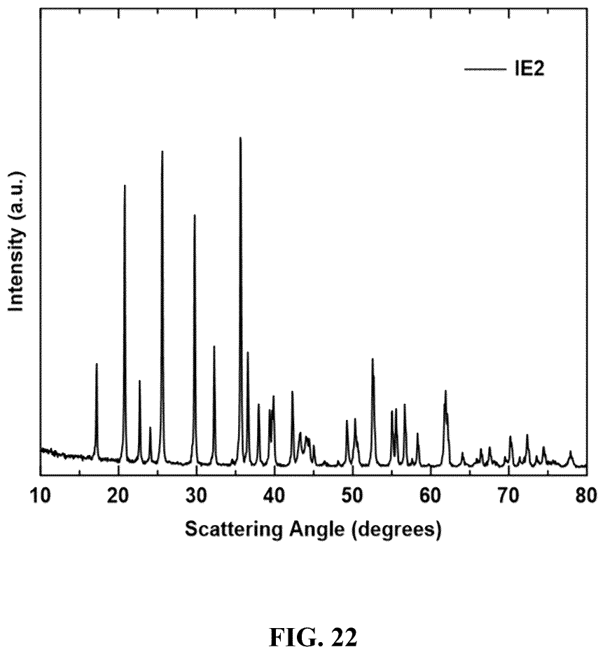

FIG. 22 shows an XRD pattern of the IE2 free particulate. Unit cell parameters, atom positions, and preferred orientation values obtained from Rietveld refinement of IE2 free particulate are listed in Table 2. The XRD pattern is characteristic of highly crystalline LiFePO₄ having an ordered olivine structure indexed to the orthorhombic Pnma space group. By Rietveld refinement, it was found that the LFP grains in the IE2 free particulate had a preferred orientation with a preferred orientation direction of [101] and with a preferred orientation parameter of 0.93. This indicates that the LFP grains that make up the IE2 free particles are in the form of plate-like crystals that are arranged in inter-grain layers within the IE2 free particles such that the faces of the LFP plate-like crystals are preferentially aligned with the major planes of the IE2 free particles. Also, by Rietveld refinement it was found that the LFP grains had an average grain size of 145 nm and that the sample had 0.04% crystallographic strain.

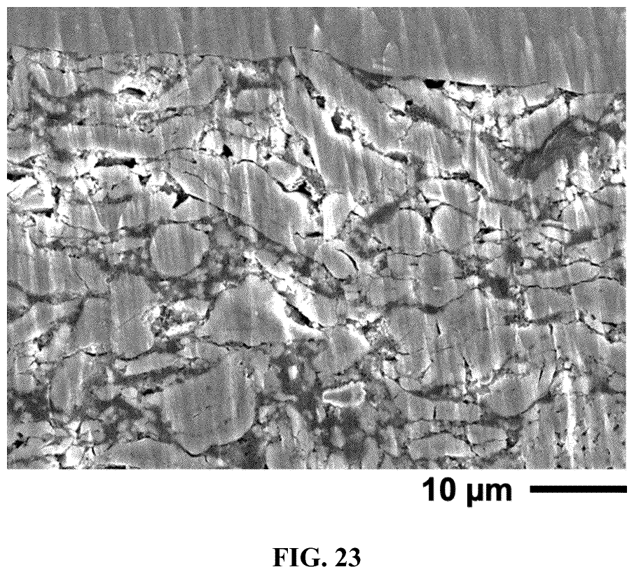

Electrodes were prepared in the same way as those in example IE1, excepting utilizing IE2 as the electroactive cathode material. The electrode coating was subjected to calendering, resulting in an electrode porosity of 30%. FIG. 23 shows a cross-section image of this electrode. From this cross section it can be seen that most of the particles have a substantially oblong or potato-shape. Inter-grain layering is also apparent in these particles. In fact, the particles are nearly the same in every aspect as IE2, excepting their external dimensions are different, resulting in a potato-like shape instead of a flake-shape and a lower VSA. Due to most of the particles of IE2 not being shaped like flakes, there is much less preferential alignment of the particles in this electrode, compared to the electrode made from IE1. This is likely why the IE2 electrode had a higher electrode porosity than the IE1 electrode.

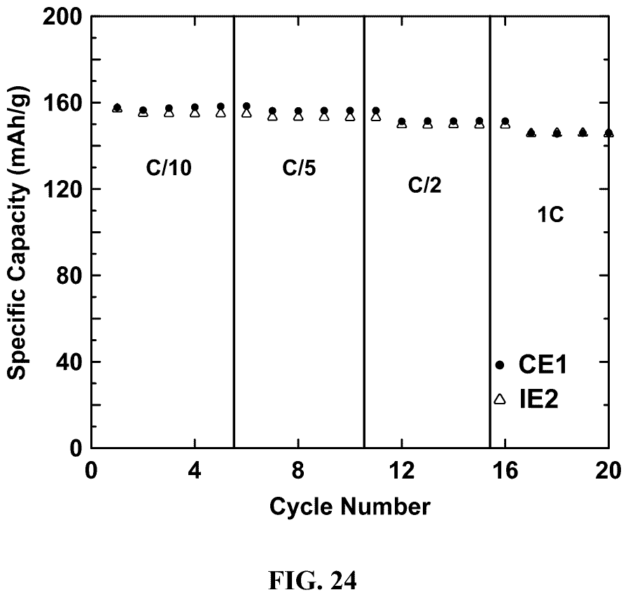

Cells were constructed utilizing IE2 electrodes and cycled according to P3. Additional cells utilizing CE1 electrodes were also cycled according to P3 for comparison. FIG. 24 shows the capacity vs. cycle number of these cells. The first cycle discharge capacity and the average discharge capacity obtained at each tested discharge rate are listed in Table 5. Despite its much larger particle size and most particles being substantially oblong or potato-shaped, the IE2 has nearly the same rate capability as CE1. This example shows that the unique microstructure obtained by the MM process enables LFP/graphite free particulate to be made that comprises mostly of large (10 μm average size) potato-shaped free particles but has electrochemical characteristics that are superior in many respects compared to conventional LFP that consists mostly of submicron particles.

TABLE 5
Electrochemical testing results. All capacities
listed are discharge capacities.

| | First Cycle | Average | Average | Average | Average |
|---|---|---|---|---|---|
| | C/20 | C/10 | C/5 | C/2 | 1C |
| | Capacity | Capacity | Capacity | Capacity | Capacity |
| Example | (mAh/g) | (mAh/g) | (mAh/g) | (mAh/g) | (mAh/g) |
| CE2 | 157.70 | 157.70 | 156.28 | 151.44 | 145.80 |
| IE2 | 157.60 | 155.40 | 153.69 | 150.20 | 146.29 |

### Example (IE3)

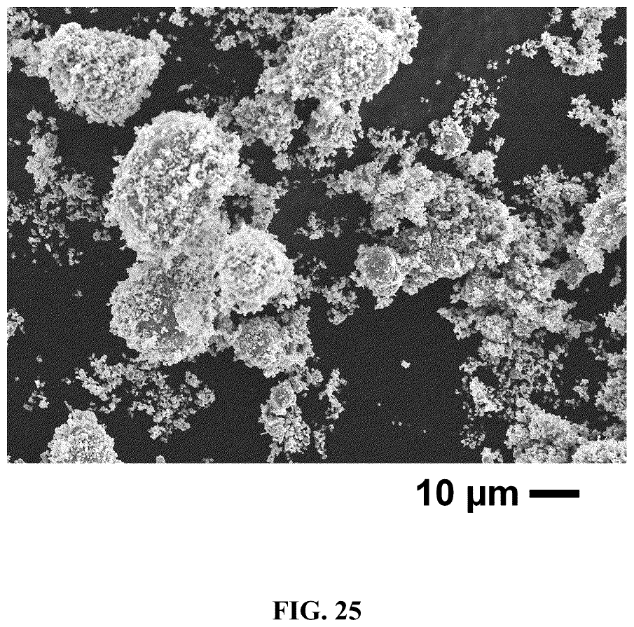

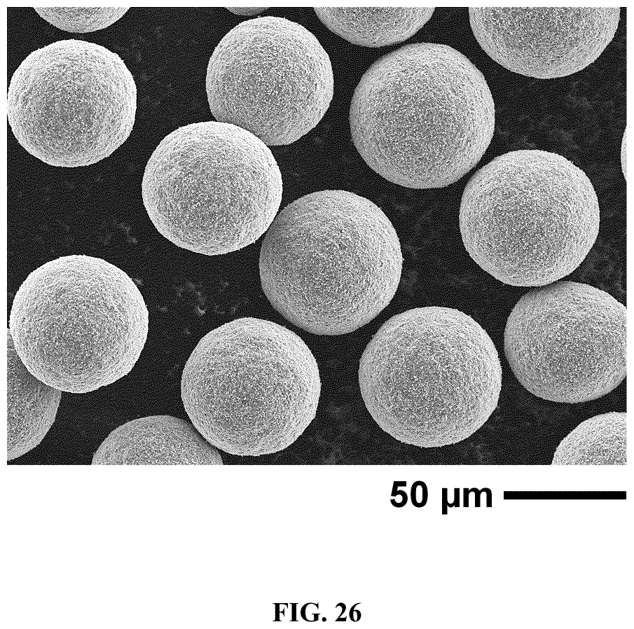

25 g of Li [Ni_{0.6}Mn_{0.2}Co_{0.2}]O₂ (this formula denoted as NMC622) particulate (ShanShan T61 (#854)) was ground with an automatic grinder (RMO mortar grinder, Restch) for 30 minutes, resulting in the formation of submicron particulate NMC, as shown in the SEM image in FIG. 25. This feedstock particulate was mixed with 225 g of ZrO₂ spheres (50 μm, Glen Mills) which served as template particles and this mixture was mechanofusion processed at 1510 rpm for 30 minutes. Following the 30 minutes of mechanofusion processing, a uniform smooth coating of NMC622 was achieved on the ZrO₂ spheres as shown in FIG. 26.

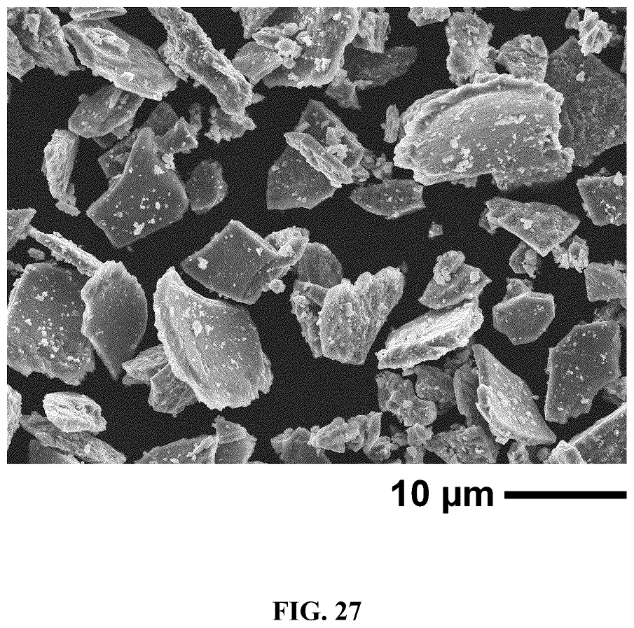

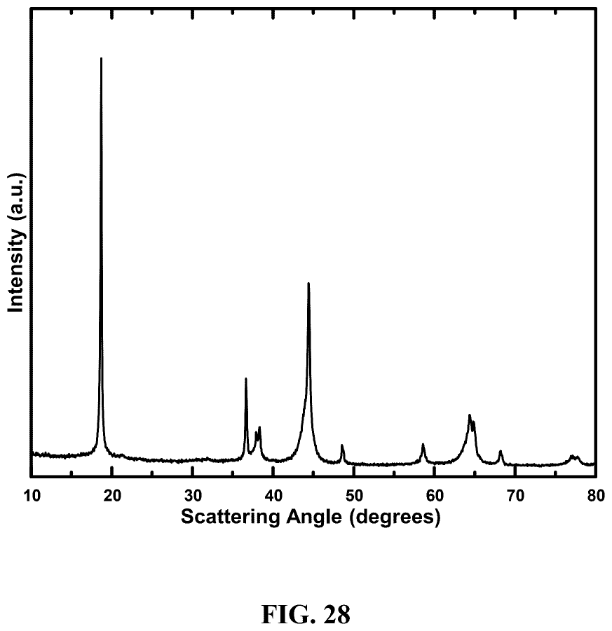

The coated ZrO₂ spheres were then impact milled and much of the NMC622 flaked off during the impact milling process. The free flake particles were then separated from the partially coated ZrO₂ spheres using a 38 μm sieve. A SEM image of the recovered free flake particulate is shown in FIG. 27. The free flake particles have a characteristic flake morphology with a flake width of 10-15 μm and a flake thickness of 1-2 μm. FIG. 28 shows an XRD pattern of the recovered free flake particulate. Characteristics peaks of NMC622 are evident however, the peak widths are broader. This indicates a decrease in grain size and formation of defects in the structure following MM processing.

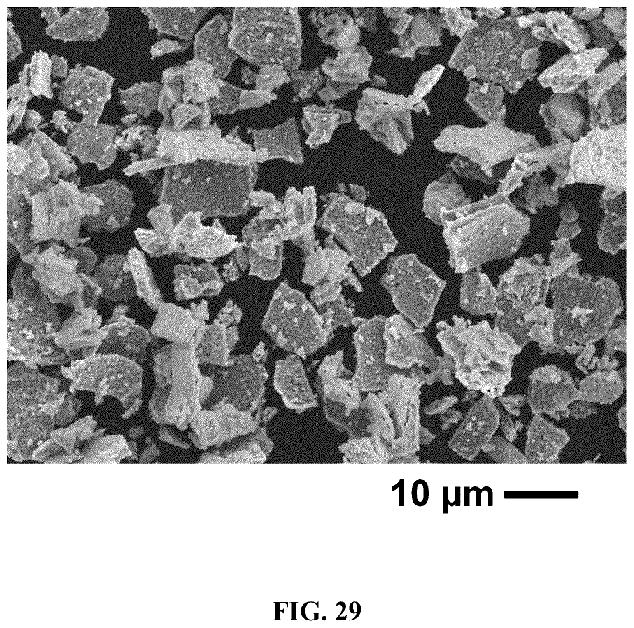

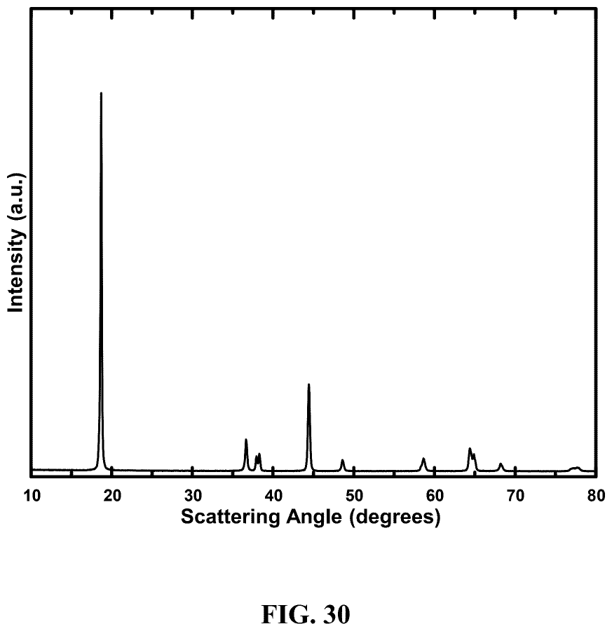

To remove the defects formed, the free flake particulate was heated in flowing O₂ gas at a temperature of 800° for 8 hours to obtain the final NMC622 free flake particulate. FIG. 29 shows an SEM image of the resulting IE3 free flake particulate. It retains the characteristics flake morphology of the free flake particles shown in FIG. 27. In addition, some of the flake particles have of exfoliated during the heating step, revealing that the NMC622 grains are arranged in inter-grain layers that are parallel with the flake basal plane, with each inter-grain layer being at most about 200 nm thick. The IE3 free flake particulates have a flake diameter of 10-15 μm and a flake thickness of 1-2 μm and a BET surface area of 0.4261 m²/g. The density of the IE3 free flake particulate was measured to be 4.874 g/ml. Combined with the BET surface area, this corresponds to a VSA of 2.07 m²/ml. FIG. 30 shows an XRD pattern of the IE3 free flake particulate. It observed that the XRD peaks are much narrower compared to the XRD pattern shown in FIG. 28. This indicates the heating step after MM processing resulted in grain growth and removal of any crystal defects that occurred following mechanofusion processing.

From the IE3 XRD pattern, the average NMC 622 grain size and strain were determined to be 161 nm and 0.24%, respectively. By Rietveld refinement of this XRD pattern, it was determined that the NMC lattice constants were a=2.87261 Å and c=14.2179 Å and that a preferred orientation of the NMC grains existed with a preferred orientation direction of [110] direction and with a preferred orientation parameter of 1.308. This indicates that the NMC 622 grains that make up the IE3 free particles are in the form of needle-like crystals that are arranged in inter-grain layers within the IE3 free flake particles such that the long-axes of the NMC 622 needle-like crystals are preferentially aligned with the major planes of the IE2 free flake particles.

Since the measured density is slightly greater than the theoretical density as determined from the NMC lattice constants, the internal porosity of IE3 free flake particulate was determined to be 0%.

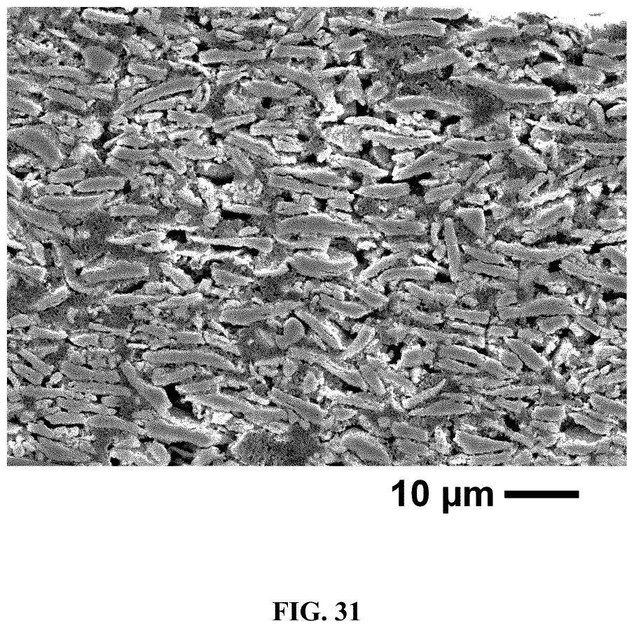

An electrode with the IE3 free flake particulate acting as the electroactive material was formulated according to Table 2. An electrode coating density of 3.531 g/cm³ was achieved, corresponding to an electrode porosity of 15%. Since flake morphology can provide better packing properties, lower porosities can be achieved without the detriment effect of particle cracking. FIG. 31 shows an SEM image of a BIB cross-section of the electrode coating of IE3. It is comprised of NMC622 free flake particulate with carbon black and porosity residing in between the gaps of the particles. The free flake particles have an average aspect ratio of about 6 and are preferentially oriented parallel with the electrode current collector. It is believed that this preferential orientation enables the ability the high coating density of this electrode.

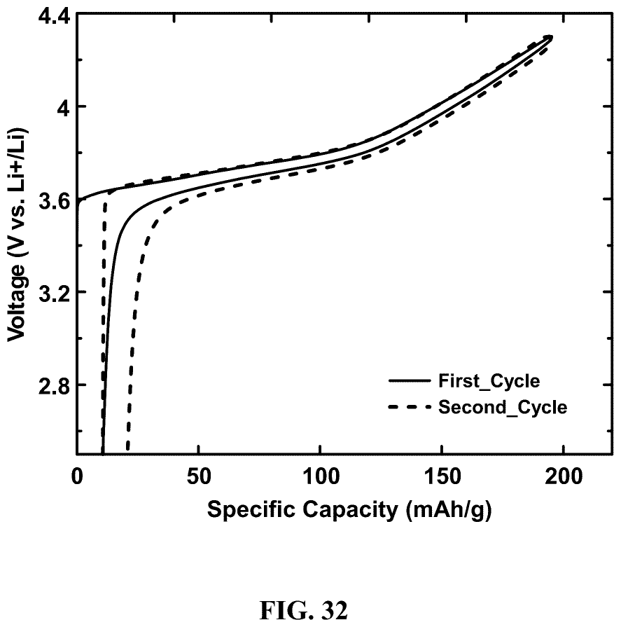

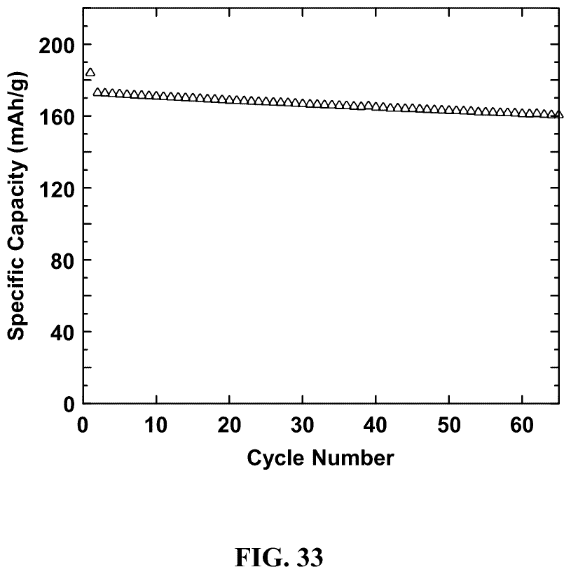

Lithium half-cells were prepared using the electrode coating of IE3 as the working electrode and cycled according to P1. FIG. 32 shows the voltage curve of one these cells. The voltage curve is characteristic of NMC622. The cell had an ICE of 94.8% and a reversibly capacity of 189.78 mAh/g with an average discharge voltage of 3.79 V. Using the electrode coating density, listed in Table 3 a coating energy density of 2473 Wh/L was obtained. FIG. 33 shows the capacity of the same cell shown in FIG. 32 plotted as a function of cycle number. The cell had a capacity fade of 12.8% up to 65 cycles and an average CE of 99.5%.

The preceding examples demonstrate that free particulate useful for battery applications can be made simply and quickly using the dry processing method according to embodiments herein. Further, the particulate and electrodes made therefrom can have unique characteristics that are particularly desirable for battery applications.

All of the above U.S. patents, U.S. patent applications, foreign patents, foreign patent applications and non-patent publications referred to in this specification, are incorporated herein by reference in their entirety.

While particular elements, embodiments and applications of the present invention have been shown and described, it will be understood, of course, that the invention is not limited thereto since modifications may be made by those skilled in the art without departing from the spirit and scope of the present disclosure, particularly in light of the foregoing teachings. For instance, it would be expected that other particulate material and electrodes similar to the LiFePO₄ and electrodes prepared to date can also be made with similarly unique characteristics. Such modifications are to be considered within the purview and scope of the claims appended hereto.

1. A method of making free particles comprising:
obtaining an amount of feedstock particles and an amount of template particles;
dry mechanofusing the amounts of the feedstock particles and the template particles to form coated template particles comprising a feedstock particle coating on the template particles;
impact milling the coated template particles such that the feedstock particle coating breaks off the template particles to form free particles; and
separating the free particles from the template particles.

2. The method of claim 1, wherein the template particles are spherically shaped and less than 200 μm in diameter.

3. The method of claim 1, wherein the template particles are ZrO₂.

4. (canceled)

5. The method of claim 1, wherein the feedstock particles comprise AₓT_{y}M_{z}O₂ or AₓT_{y}M_{z}PO₄, wherein:
$$x \geq 0 ;$$
$$y \geq 0.5 ;$$
$$z \geq 0 ;$$
A is one or more insertable alkali metals;
T is one or more first row transitional metals; and
M is selected from the group consisting of Mg, Al, Ti, Zr, W, Zn, Mo, K, Na, Si, Nb, and Ta.

6. The method of claim 1, wherein the feedstock particles comprise LiFePO₄ and graphite and the free particles comprise a blend of LiFePO₄ and graphite.

7. The method of claim 1, wherein the feedstock particles comprise NMC and the free particles comprise NMC.

8. The method of claim 1, wherein the amounts of feedstock particles and template particles obtained are such that the ratio of the true volume of feedstock particles to the surface area of the template particles corresponds to a coating thickness of 0.1 μm-50 μm.

9. The method of claim 1, wherein the impact milling is centrifugal impact milling.

10. The method of claim 1, wherein the mechanofusing time is in a range from 30 seconds to 5 hours and the impact milling time is in a range from 5 seconds to 1 minute.

11. (canceled)

12. The method of claim 1, further comprising heating the free particles that have been separated from the template particles at temperatures exceeding 200 degrees Celsius to produce an electroactive cathode material.

13. (canceled)

14. The method of claim 1, wherein the free particulate is configured to be provided in a porous electroactive coating on a current collector of an electrochemical cell.

15. A free particulate comprising free particles of electroactive material that comprise greater than 80% by weight of a metal oxide or a metal phosphate electroactive phase, have a density greater than 3 g/ml, an average particle size in a range from 1 μm to 30 μm, and wherein the metal oxide or a metal phosphate electroactive phase consists essentially of crystalline grains between 20 nm and 300 nm in size, wherein:
the metal oxide and metal phosphate grains in the free particles have a preferred orientation with respect to the major plane of the particles with a preferred orientation parameter that is greater than 1.02 or less than 0.98;
the free particles have an average internal porosity less than 20%;
the volumetric surface area of the free particles is less than 30 m²/ml; and
the average aspect ratio of the free particles is greater than 1.5.

16. (canceled)

17. (canceled)

18. The free particulate of claim 15, additionally comprising a conductive additive comprising carbon.

19. The free particulate of claim 18, wherein the conductive additive comprises graphite.

20. (canceled)

21. The free particulate of claim 15, wherein the crystalline grains have a crystallographic strain less than 1% or the crystalline grains are smaller than 200 nm.

22. (canceled)

23. The free particulate of claim 15, wherein the free particles are flakes that are greater than 80% by weight LiFePO₄, have an average flake diameter in a range from 5 μm to 50 μm, an average flake thickness in a range of 0.1 μm-10 μm, and an average aspect ratio of at least 5, and a surface area that is less than 8 m²/g.

24. The free particulate of claim 23, wherein the average flake diameter is in a range from 5 μm to 25 μm and the average flake thickness is in a range of 0.1 μm-5 μm or wherein the LiFePO₄ consists of grains with an average size less than 0.3 μm.

25. (canceled)

26. The free particulate of claim 23, wherein the free particles have a curvature with a radius of curvature in a range from 10 μm to 100 μm.

27. The free particulate of claim 15, wherein:
the free particles are greater than 80% by weight LiFePO₄;
the LiFePO₄ consists essentially of crystalline grains;
the crystalline grains of LiFePO₄ have a preferred orientation in the [101] direction with respect to the major plane of the free particles with a preferred orientation parameter that is less than 0.98; and
the free particles comprise carbon regions residing between the LiFePO₄ grains and the carbon regions are in a range between 0.1% to 10% by weight.

28. (canceled)

29. The free particulate of claim 15, wherein the free particles are greater than 80% by weight NMC; the NMC consists essentially of crystalline grains; and the crystalline grains of NMC have a preferred orientation in the [110] direction with respect to the major plane of the free particles with a preferred orientation parameter that is greater than 1.02.

30. An electrode for an electrochemical cell comprising a porous electroactive coating on a current collector, the electroactive coating comprising greater than 80% by weight free particulate and a binder, wherein:
the free particulate comprises the free particles of claim 15;
the electrode coating has an electrode porosity that is less than 20%; and
a loading of the electrode coating on the current collector is greater than 2 mAh/cm².

31. The electrode of claim 30 wherein the free particulate comprises carbon.

32. The electrode of claim 30 wherein the electrode coating has an electrode porosity that is less than 15%.

33. The electrode of claim 30 wherein the loading of the electrode coating on the current collector is greater than 3 mAh/cm², wherein the electrode is provided in a lithium ion rechargeable battery.

34. (canceled)

35. (canceled)

36. (canceled)
